(19) United States
(12) Patent Application Publication
(10) Pub. No.: US 2024/0055603 A1
(43) Pub. Date: Feb. 15, 2024

(54) RECYCLED DIESEL SOOT PARTICLES FOR USE AS AN ELECTRODE MATERIAL FOR ALKALI METAL ION BATTERIES

(71) Applicants: University of Southern California, Los Angeles, CA (US); The Board of Regents for the Oklahoma Agricultural and Mechanical Colleges, Stillwater, OK (US)

(72) Inventors: Stephen B. CRONIN, Los Angeles, CA (US); Sisi YANG, Los Angeles, CA (US); Özgür ÇAPRAZ, Stillwater, OK (US); Bertan OZDOGRU, Stillwater, OK (US)

(73) Assignees: University of Southern California, Los Angeles, CA (US); The Board of Regents for the Oklahoma Agricultural and Mechanical Colleges, Stillwater, OK (US)

(21) Appl. No.: 18/267,194

(22) PCT Filed: Oct. 5, 2021
(86) PCT No.: PCT/US2021/053582

§ 371 Date: Jun. 14, 2023

Related U.S. Application Data
(60) Provisional application No. 63/127,896, filed on Dec. 18, 2020.

(51) Int. Cl. H01M 4/583; H01M 4/04; H01M 4/62; H01M 10/0525; H01M 10/054

(52) U.S. Cl. CPC H01M 4/583; H01M 4/0404; H01M 4/622; H01M 4/625; H01M 10/0525; H01M 10/054; H01M 2004/027

(57) ABSTRACT

This invention relates to alkali metal (Li, Na, K) ion batteries, electrodes for alkali metal ion batteries, and methods for manufacturing electrodes for alkali metal ion batteries.

### CROSS-REFERENCE TO RELATED APPLICATION

This application claims the benefit under 35 U.S.C. § 119(e) of U.S. Provisional Patent Application No. 63/127,896 filed on Dec. 18, 2020, which is incorporated herein by reference in its entirety.

### STATEMENT REGARDING FEDERALLY SPONSORED RESEARCH OR DEVELOPMENT

This invention was made with government support under Grant No. W911NF-19-1-0257 awarded by the Army Research Office (ARO), and by a grant from the National Center for Sustainable Transportation (NCST), supported by U.S. Department of Transportation's University Transportation Centers Program. The government has certain rights in the invention.

### FIELD OF THE INVENTION

This invention relates to alkali metal (Li, Na, K) ion batteries, electrodes for alkali metal ion batteries, and methods for manufacturing electrodes for alkali metal ion batteries.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Li ion batteries have become a ubiquitous part of our society, often going unnoticed. As the global Li ion battery capacity continues to grow at its current rate, innovations in high surface area materials will be needed in order to sustain this grown and meet the economic pressures of supply and demand. By 2030, it is estimated that the global Li ion battery capacity will exceed 1 TWh, and cheap rechargeable batteries remain a key enabling technology for electronic vehicles and solar farms. The present composite electrodes in commercialized batteries consist of three main components: active materials, conductive additives, and polymer binders. Active materials intercalate with Li ions during charging/discharging the Li-ion battery. Common active materials in commercialized cathode electrodes are lithium iron phosphate (LFP), lithium manganese oxide (LMO), lithium cobalt oxide (LCO), and lithium nickel manganese cobalt oxide (NMC). These cathode electrodes, however, have a poor electrical conductivity. For example, the electronic conductivity of LMO and LFP are ˜10⁻⁶ and 10⁻⁹ S/cm, respectively. Carbon additives play an important role in creating conductive networks in composite electrode structures in order to improve battery performance, and the impact of conductive carbon on the capacity profile of electrodes is significant.

Therefore, there is an ongoing need for improvements in all aspects of alkali metal (Li, Na, K) ion battery technology, particularly for new conductive additives and active materials for alkali metal ion battery electrodes. The embodiments of the present invention address that need.

### SUMMARY OF THE INVENTION

The following embodiments and aspects thereof are described and illustrated in conjunction with systems, apparatus, articles of manufacture, compositions, and methods which are meant to be exemplary and illustrative, not limiting in scope.

In various embodiments, the present invention provides an electrode for a battery, the electrode comprising an active material, wherein the active material is diesel exhaust soot particles. In some embodiments, the electrode further comprises a binder, and an electrically conductive additive. In some embodiments, the binder is a polymeric binder. In some embodiments, the binder is selected from the group consisting of a carboxymethyl cellulose, carboxymethyl cellulose sodium salt, and combinations thereof. In some embodiments, the electrically conductive additive is a conductive carbon material. In some embodiments, the conductive carbon material is conductive carbon black. In some embodiments, the diesel exhaust soot particles are annealed. In some embodiments, the diesel exhaust soot particles comprise amorphous carbon. In some embodiments, the amorphous carbon is porous amorphous carbon. In some embodiments, the electrode is a composite electrode. In some embodiments, the diesel exhaust soot particles are recycled diesel exhaust soot particles. In some embodiments, the diesel exhaust soot particles are about 20 nm to about 200 nm in diameter. In some embodiments, the electrode has a cycle life of at least about 500 cycles. In some embodiments, the electrode is capable of pseudocapacitive charging. In some embodiments, the electrode is an anode electrode. In some embodiments, the electrode is capable of storing and discharging ions, wherein the ions are selected from the group consisting of lithium ions, sodium ions, potassium ions, and combinations thereof. In some embodiments, the battery is capable of being charged in a time period, wherein the time period is selected from 3 minutes to 60 minutes. In some embodiments, the battery is selected from the group consisting of a lithium ion battery, a sodium ion battery, a potassium ion battery, and combinations thereof. In some embodiments, the battery is selected from the group consisting of a rechargeable lithium ion battery, a rechargeable sodium ion battery, a rechargeable potassium ion battery, and combinations thereof. In some embodiments, the battery is capable of storing and discharging ions, wherein the ions are selected from the group consisting of lithium ions, sodium ions, potassium ions, and combinations thereof. In some embodiments, the battery is capable of pseudocapacitive charging.

In various embodiments the present invention provides a battery, comprising: an anode, a cathode, a separator, and an electrolyte, wherein the anode comprises an active material, and wherein the active material is diesel exhaust soot particles. In some embodiments, the anode further comprises a binder, and an electrically conductive additive. In some embodiments, the binder is a polymeric binder. In some embodiments, the binder is selected from the group consisting of a carboxymethyl cellulose, carboxymethyl cellulose sodium salt, and combinations thereof. In some embodiments, the electrically conductive additive is a conductive carbon material. In some embodiments, the conductive carbon material is conductive carbon black. In some embodiments, the diesel exhaust soot particles are annealed. In some embodiments, the diesel exhaust soot particles comprise amorphous carbon. In some embodiments, the amorphous carbon is porous amorphous carbon. In some embodiments, the anode is a composite anode. In some embodiments, the diesel exhaust soot particles are recycled diesel exhaust soot particles. In some embodiments, the diesel exhaust soot particles are about 20 nm to about 200 nm in diameter. In some embodiments, the anode has a cycle life of at least about 500 cycles. In some embodiments, the anode is capable of storing and discharging ions, wherein the ions are selected from the group consisting of lithium ions, sodium ions, potassium ions, and combinations thereof. In some embodiments, the anode is capable of pseudocapacitive charging. In some embodiments, the battery is capable of being charged in a time period, wherein the time period is selected from 3 minutes to 60 minutes. In some embodiments, the battery is selected from the group consisting of a lithium ion battery, a sodium ion battery, a potassium ion battery, and combinations thereof. In some embodiments, the battery is selected from the group consisting of a rechargeable lithium ion battery, a rechargeable sodium ion battery, a rechargeable potassium ion battery, and combinations thereof. In some embodiments, the battery is capable of storing and discharging ions, wherein the ions are selected from the group consisting of lithium ions, sodium ions, potassium ions, and combinations thereof. In some embodiments, the battery is capable of pseudocapacitive charging.

In various embodiments the present invention provides a method of manufacturing an electrode for a battery, comprising: collecting diesel exhaust soot particles; annealing the diesel exhaust soot particles; mixing the annealed diesel exhaust soot particles with a binder, water, and an electrically conductive additive to form a slurry; casting the slurry on a current collector; and drying the slurry to provide the electrode. In some embodiments, the binder is a polymeric binder. In some embodiments, the binder is selected from the group consisting of a carboxymethyl cellulose, carboxymethyl cellulose sodium salt, and combinations thereof. In some embodiments, the electrically conductive additive is a conductive carbon material. In some embodiments, the conductive carbon material is conductive carbon black. In some embodiments, the diesel exhaust soot particles are collected from diesel exhaust soot. In some embodiments, the diesel exhaust soot particles are collected from diesel exhaust soot using electrostatic precipitation. In some embodiments, the diesel exhaust soot particles are about 20 nm to about 200 nm in diameter. In some embodiments, the diesel exhaust soot particles comprise amorphous carbon. In some embodiments, the amorphous carbon is porous amorphous carbon. In some embodiments, the electrode is a composite electrode. In some embodiments, the electrode is capable of storing and discharging ions, wherein the ions are selected from the group consisting of lithium ions, sodium ions, potassium ions, and combinations thereof. In some embodiments, the electrode is capable of pseudocapacitive charging. In some embodiments, the diesel exhaust soot particles are annealed at a temperature from 100° C. to 250° C. for 1 hour to 4 hours. In some embodiments, the battery is selected from the group consisting of a lithium ion battery, a sodium ion battery, a potassium ion battery, and combinations thereof. In some embodiments, the battery is selected from the group consisting of a rechargeable lithium ion battery, a rechargeable sodium ion battery, a rechargeable potassium ion battery, and combinations thereof. In some embodiments, the battery is capable of storing and discharging ions, wherein the ions are selected from the group consisting of lithium ions, sodium ions, potassium ions, and combinations thereof. In some embodiments, the battery is capable of pseudocapacitive charging.

Exemplary embodiments are illustrated in referenced figures. It is intended that the embodiments and figures disclosed herein are to be considered illustrative rather than restrictive.

### BRIEF DESCRIPTION OF THE DRAWINGS

FIG. 1A-FIG. 1C depicts in accordance with various embodiments of the invention, high-resolution transmission electron microscope (HRTEM) image of diesel soot particles (FIG. 1A), high-resolution transmission electron microscope (HRTEM) image of diesel soot particles (FIG. 1B), and scanning mobility particle sizer (SNIPS) spectra of diesel soot particles (i.e., particulate matter) (FIG. 1C).

FIG. 2A-FIG. 2B depicts in accordance with various embodiments of the invention, current-voltage curves taken from LMO electrodes containing annealed diesel soot, Super-P® (commercially available activated carbon, typically used in Li-ion batteries) (FIG. 2A), and unannealed diesel soot (FIG. 2B).

FIG. 3A-FIG. 3B depicts in accordance with various embodiments of the invention, discharging capacity (line) and Coulombic efficiency (open square symbol with line) of LFP electrodes containing Super P® carbon or annealed soot (FIG. 3A). The composite electrodes were cycled at 1C rate. Impedance plots of the electrodes after 100 cycles at 1C rate (FIG. 3B).

FIG. 4 depicts in accordance with various embodiments of the invention, relative discharge capacity of LFP electrodes containing Super P® carbon (blue color) or annealed soot carbon (red color) cycled at C/5, C/2, 1C, 2C, 5C and 10C for four cycles each.

FIG. 5A-FIG. 5C depicts in accordance with various embodiments of the invention, Electrode Slurry containing with annealed diesel soot in Thinky Mixer Containers (FIG. 5A). The Picture of the slurry after casted on the aluminum current collector, and dried (FIG. 5B). Picture of electrode punched for coin-cell manufacturing (FIG. 5C).

FIG. 6A-FIG. 6C depicts in accordance with various embodiments of the invention, Electrode Slurry containing with Super P® carbon in Thinky Mixer Containers (FIG. 6A). The Picture of the slurry after casted on the aluminum current collector, and dried (FIG. 6B). Picture of electrode punched for coin-cell manufacturing (FIG. 6C).

FIG. 7A-FIG. 7B depicts in accordance with various embodiments of the invention, discharging capacity of LMO electrodes containing Super P® carbon, annealed soot or unannealed soot (FIG. 7A). The composite electrodes were cycled at 1C rate. Impedance plots of the electrodes before and after 100 cycles at 1C rate (FIG. 7B).

FIG. 8A-FIG. 8C depicts in accordance with various embodiments of the invention, HRTEM images of unannealed soot particles.

FIG. 9A-FIG. 9C depicts in accordance with various embodiments of the invention, HRTEM images of annealed soot particles.

FIG. 10A-FIG. 10C depicts in accordance with various embodiments of the invention, characterization of material chemistry: XRD analysis of annealed soot powders (FIG. 10A), XPS spectrum of annealed soot powder (FIG. 10B), and Raman spectrum of pristine soot composite electrode (FIG. 10C).

FIG. 11A-FIG. 11C depicts in accordance with various embodiments of the invention, electrochemical behavior of soot composite anode. Cyclic voltammetry at 200 uV/s for 5 cycles (FIG. 11A), electrochemical impedance spectra of the composite electrode before and after 5 cycles cyclic voltammetry at 200 uV/s (FIG. 11B), potential-capacity profiles during the first 3 galvanostatic cycles at C/2 rate (FIG. 11C).

FIG. 12A-FIG. 12B depicts in accordance with various embodiments of the invention, rate performance of the electrode cycled at different C-rates (FIG. 12A), potential-capacity curves for charge and discharge cycles at different C-rates (FIG. 12B).

FIG. 13A-FIG. 13B depicts in accordance with various embodiments of the invention, columbic efficiency, capacity retention, and discharge capacity of the soot composite electrode cycled 4C for 500 cycles (FIG. 13A). Raman spectra of the electrode taken before cycling, after 1^{st} lithiation and after 500 cycles (FIG. 13B).

FIG. 14A-FIG. 14B depicts in accordance with various embodiments of the invention, Li⁺ charge storage mechanisms in soot composite electrode. CV curves of the electrode at various scan rates from 25-2500 uV/s (FIG. 14A). Relationship between current peak and scan rate (FIG. 14B).

FIG. 15A-FIG. 15D depicts in accordance with various embodiments of the invention, relationships between i(V)/v^{0.5} vs v^{0.5} for calculating constants k₁ and k₂ at potentials between 0.01-0.5 V (FIG. 15A), 0.6-1.0 V (FIG. 15B), 1.1-1.5 V (FIG. 15C), 1.6-2.0 V (FIG. 15D).

FIG. 16A-FIG. 16C depicts in accordance with various embodiments of the invention, current response (black straight line) and capacitive charge storage contributions (colored with blue) at 25 uV/s (FIG. 16A), current response (black straight line) and capacitive charge storage contributions (colored with blue) at 2500 uV/s (FIG. 16B). Contribution ratio of diffusion-limited and capacitive factors on the charge storage at scan rates between 25-2500 uV/s (FIG. 16C).

FIG. 17A-FIG. 17K depicts in accordance with various embodiments of the invention, capacitive charge storage contributions at 50 uV s⁻¹ (FIG. 17A), 75 uV s⁻¹ (FIG. 17B), 100 uV s⁻¹ (FIG. 17C), 150 uV s⁻¹ (FIG. 17D), 250 uV s⁻¹ (FIG. 17E), 500 uV s⁻¹ (FIG. 17F), 750 uV s⁻¹ (FIG. 17G), 1000 uV s⁻¹ (FIG. 17H), 1250 uV s⁻¹ (FIG. 17I), 1500 uV s⁻¹ (FIG. 17J), and 2000 uV s⁻¹ (FIG. 17K).

FIG. 18A-FIG. 18B depicts in accordance with various embodiments of the invention, rate performance of the electrode cycled at different C-rates for Na-ion storage (FIG. 18A), potential-capacity curves for charge and discharge cycles at different C-rates (FIG. 18B). The electrolyte was 1 M NaClO₄ in EC-DMC electrolyte and the soot composite electrode was cycled against Na counter electrode.

FIG. 19 depicts in accordance with various embodiments of the invention, capacity retention of the soot composite anode when cycled at 1 C rate against Li counter metal.

### DETAILED DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

One skilled in the art will recognize many methods and materials similar or equivalent to those described herein, which could be used in the practice of the present invention. Other features and advantages of the invention will become apparent from the following detailed description, taken in conjunction with the accompanying drawings, which illustrate, by way of example, various features of embodiments of the invention. Indeed, the present invention is in no way limited to the methods and materials described. For convenience, certain terms employed herein, in the specification, examples and appended claims are collected here.

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. Unless otherwise defined, all technical and scientific terms used herein have the same meaning as commonly understood by one of ordinary skill in the art to which this invention belongs. It should be understood that this invention is not limited to the particular methodology, protocols, and reagents, etc., described herein and as such can vary. The definitions and terminology used herein are provided to aid in describing particular embodiments, and are not intended to limit the claimed invention, because the scope of the invention is limited only by the claims.

As used herein the term “comprising” or “comprises” is used in reference to compositions, methods, systems, articles of manufacture, apparatus, and respective component(s) thereof, that are useful to an embodiment, yet open to the inclusion of unspecified elements, whether useful or not. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). Although the open-ended term “comprising,” as a synonym of terms such as including, containing, or having, is used herein to describe and claim the invention, the present invention, or embodiments thereof, may alternatively be described using alternative terms such as “consisting of” or “consisting essentially of.”

Unless stated otherwise, the terms “a” and “an” and “the” and similar references used in the context of describing a particular embodiment of the application (especially in the context of claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. The abbreviation, “e.g.” is derived from the Latin exempli gratia, and is used herein to indicate a non-limiting example. Thus, the abbreviation “e.g.” is synonymous with the term “for example.” No language in the specification should be construed as indicating any non-claimed element essential to the practice of the application.

“Optional” or “optionally” means that the subsequently described circumstance may or may not occur, so that the description includes instances where the circumstance occurs and instances where it does not.

The terms “lithium ion” and “Li ion” and “lithium-ion” and “Li-ion” have the same meaning and are used interchangeably herein.

In some embodiments, the numbers expressing quantities of reagents, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The term “C-rates” means charging rates.

The terms “sodium ion” and “Na ion” and “sodium-ion” and “Na-ion” have the same meaning and are used interchangeably herein.

The terms “potassium ion” and “K ion” and “potassium-ion” and “K-ion” have the same meaning and are used interchangeably herein.

As used herein, lithiation refers to the insertion of Li⁺ ions into the composite electrode during the discharge cycle, and delithiation refers to the extraction of Li⁺ ions from the composite electrode during the charge cycle.

The term “cycle life” as used herein refers to the number of charge and discharge cycles that an electrode or battery can complete before losing significant performance.

The term “pseudocapacitive charging” as used herein refers to electrochemical storage of electricity in an electrode by faradaic charge transfer that originates by reversible faradaic redox, electrosorption or intercalation processes on the surface of an electrode. This process is accompanied by an electron charge-transfer between electrolyte and electrode coming from a de-solvated and adsorbed ion where one electron per charge unit is involved. The adsorbed ion has no chemical reaction with the atoms of the electrode (i.e., no chemical bonds are formed) since only a charge-transfer reaction occurs.

“Black Carbon” consists of pure carbon in several linked forms and is a component of fine particulate air pollution (e.g., PM_{2.5}) and soot. The term “Black Carbon” is different than the term “Carbon Black” and should not be confused with “Carbon Black”.

“Carbon Black” refers to a material produced by the incomplete combustion of heavy petroleum products such as FCC tar, coal tar, ethylene, cracking tar, or vegetable matter. Carbon black is a form of paracrystalline carbon that has a high surface-area-to-volume ratio. Carbon black is dissimilar to soot in that carbon black has a much higher surface-area-to-volume ratio and significantly lower polycyclic aromatic hydrocarbon (PAH) content. The term “Carbon Black” is different than the term “Black Carbon” and should not be confused with “Black Carbon”.

The term “soot” refers to a black substance comprised largely of impure amorphous carbon particles resulting from the incomplete combustion of hydrocarbons or organic matter. Soot has many different sources, including but not limited to, coal burning, internal-combustion engines, power-plant boilers, hog-fuel boilers, ship boilers, central steam-heat boilers, waste incineration, local field burning, forest fires, fireplaces, and furnaces.

The term “recycled” as used herein means reused, repurposed, or recovered.

The wide acceptance of the serious health effects associated with nanoscale particulate matter (PM) produced by fossil fuel combustion has led to a wide range of nanotoxicology studies of the environmental emissions from the combustion of fossil fuels, cigarette smoke, and even emissions from commercial cooking processes (e.g., charbroiling). During the past couple of decades, the adverse health effects of diesel particulate emissions have been firmly established by many toxicological studies. In epidemiological studies, these ultrafine particulates have been linked to premature cardiovascular and respiratory deaths in metropolitan areas, as well as lung cancer. A 1993 study published by Dockery et al. has been cited more than 4,600 times as of the time of this writing, demonstrating the broad impact of this problem. (Dockery, D., C. Pope, X. Xu, J. Spengler, J. Ware, M. Fay, B. Ferris and F. Speizer, An Association between Air Pollution and Mortality in Six U.S. Cities. The New England Journal of Medicine, 329, 1753-1759 (1993). Diesel-fueled engines and vehicles, which are the major sources of diesel PM that accounts for about 8% of the PM2.5 in outdoor air, emit more than 70 tons of PM per day in California alone (25,000 tons of PM per year). The Air Resources Board (ARB) and U. S. EPA state that an estimated 3,500 premature deaths per year that are affiliated with respiratory and cardiovascular diseases can be attributed to diesel PM in California alone.

This has captured the attention of global organizations such as the World Health Organization (WHO), which gives an average annual guideline of 10 μg/m³ of PM_{2.5} in their air quality guidelines. Furthermore, this attention has prompted decision-makers such as the Environmental Protection Agency (EPA), Federal-Provincial Advisory Committee, and the European Union to impose standards on the emissions of nanoscale particulate matter. For example, the Euro 6 update limited the emission of particulate matter to 0.01 g/kWh for heavy duty engines and 0.005 g/km for light-duty vehicles operating in Europe, and further, more stringent air quality standards are expected in the future. Effective implementation of these policies is key to control and mitigate PM_{2.5} air pollution.

Several technologies have been developed to treat diesel particulate emissions, including diesel particulate filters (DPFs), wet scrubbers, and electrostatic precipitators (ESP). Many of these have been developed in response to increasingly stringent air quality regulations, such as those imposed by the U.S. Environmental Protection Agency (EPA), California Air Resources Board (CARB), and local air quality air management districts (AQMD). Most recently, there has been a popular trend towards zero-emissions systems. However, for most practical applications, the combustion of diesel fuel will remain a dominant source of power, requiring more advanced pollution control devices to be developed. Diesel particulate filters provide a relatively cheap solution that works well for small size engines. Over time, however, these filters become clogged, which creates engine backpressure and require regeneration at regular maintenance intervals. The main drawback of electrostatic precipitators is that they eventually need to be cleaned out, which presents the inevitable problem of how to dispose of this now highly concentrated hazardous carcinogenic material. The carbonaceous waste soot collected from these filters is currently of limited use and mostly ends up as industrial toxic waste. Potential commercial application of this waste material is needed to transform it into useful chemicals for sustainability.

Li ion batteries have become a ubiquitous part of our society, often going unnoticed. As the global Li ion battery capacity continues to grow at its current rate, innovations in high surface area materials will be needed in order to sustain this grown and meet the economic pressures of supply and demand. By 2030, it is estimated that the global Li ion battery capacity will exceed 1 TWh, and cheap rechargeable batteries remain a key enabling technology for electronic vehicles and solar farms. The present composite electrodes in commercialized batteries consist of three main components: active materials, conductive additives, and polymer binders. Active materials intercalate with Li ions during charging/discharging the Li-ion battery. Common active materials in commercialized cathode electrodes are lithium iron phosphate (LFP), lithium manganese oxide (LMO), lithium cobalt oxide (LCO), and lithium nickel manganese cobalt oxide (NMC). These cathode electrodes, however, have a poor electrical conductivity. For example, the electronic conductivity of LMO and LFP are ˜10⁻⁶ and 10⁻⁹ S/cm, respectively. Carbon additives play an important role in creating conductive networks in composite electrode structures in order to improve battery performance, and the impact of conductive carbon on the capacity profile of electrodes is significant.

The discovery of graphite anodes in the early 1990s lead to the commercialization of rechargeable lithium-ion batteries in 1991 because graphite allows reversible Li-ion insertion (i.e. intercalation) and removal from its structure. In recent years, a number of publications have come forth with various carbonaceous electrodes as alternatives to the graphite electrode from a variety of sources including prawn shells (Elizabeth, I., Singh, B. P., Trikha, S. & Gopukumar, S. Bio-derived hierarchically macro-meso-micro porous carbon anode for lithium/sodium ion batteries. J. Power Sources 329, 412-421 (2016)), corn stalk cores (Li, Y., Li, C., Qi, H., Yu, K. & Liang, C. Mesoporous activated carbon from corn stalk core for lithium ion batteries. Chem. Phys. 506, 10-16 (2018)), rice husks (Yu, K. et al. Preparation of porous carbon anode materials for lithium-ion battery from rice husk. Mater. Lett. 253, 405-408 (2019)), garlic peels (Selvamani, V., Ravikumar, R., Suryanarayanan, V., Velayutham, D. & Gopukumar, S. Garlic peel derived high capacity hierarchical N-doped porous carbon anode for sodium/lithium ion cell. Electrochim. Acta 190, 337-345 (2016)), sweet potatoes (Zheng, P. et al. Sweet potato-derived carbon nanoparticles as anode for lithium ion battery. RSC Adv. 5, 40737-40741 (2015)), wheat flour (Lim, D. G. et al. Lithium storage in structurally tunable carbon anode derived from sustainable source. Carbon N. Y. 121, 134-142 (2017)), and soot from marine gas oil (Baek, H. M., Kim, D. Y., Lee, W. J. & Kang, J. Application of soot discharged from the combustion of marine gas oil as an anode material for lithium ion batteries. RSC Adv. 10, 36478-36484 (2020)) among others. Table 1 lists the carbon sources, synthesis process and electrochemical performance of the porous carbon electrodes derived from biomass resources.

TABLE 1
Literature survey on the synthesis and the electrochemical performance
of the recycled carbon materials derived from various sources as anode in
Li-ion batteries. C-rates are based on theoretical capacity of 372 mA/g.

| Li-ion or | | | Discharge | Current | |
|---|---|---|---|---|---|
| Na-ion | | | Capacity | Density | |
| Battery | Carbon Source | Synthesis | (mAh/g) | (mA/g) | |
| Li-ion | Garlic Peel | Baking (300° C.) + KOH | 200 | 4000 | (~10.8 C.) |
| | | bath + Pyrolysis (850° C. | | | |
| | | for 2 hrs) | | | |
| Li-ion | Sweet potato | Pyrolysis (800° C. for 4 | 84 | 3720 | (~10 C.) |
| | | hrs) + Autoclave | | | |
| Li-ion | Rice husk | Autoclave + H₂SO₄ bath + | 155 | 1860 | (~5 C.) |
| | | Pyrolysis (600° C. for 1.5 | | | |
| | | hrs) | | | |
| Li-ion | soot from | Pyrolysis (1000° C. for 1 | 395 | 3720 | (~10 C.) |
| | marine gas oil | hr) | | | |
| Li-ion | prawn shells | Baking (300° C.) + NaOH | 147 | 2000 | (~5.4 C.) |
| | | bath + Pyrolysis (750° C. | | | |
| | | for 2 hrs) | | | |
| Li-ion | corn stalk cores | Baking (300° C.) | 107 | 1860 | (~5 C.) |
| Li-ion | corn stalk cores | Baking (300° C.) + | 275 | 1860 | (~5 C.) |

| | | | | |
|---|---|---|---|---|
| | | Pyrolysis (550° C. for 4 | | |
| | | hrs) + KOH bath | | |
| Na-ion | Garlic Peel | Baking (300° C.) + KOH | 142 | 500 |
| | | bath + Pyrolysis (850° C. | | |
| | | for 2 hrs) | | |
| Na-ion | prawn shells | Baking (300° C.) + NaOH | 107 | 2000 |
| | | bath + Pyrolysis (750° C. | | |
| | | for 2 hrs) | | |
| Na-ion | Onion | Baking (300° C.) + NaOH | 46 | 2000 |
| | | bath + Pyrolysis (600° C. | | |
| | | for 3 hrs) | | |
| Na-ion | low density | Pyrolysis (700° C. under | 92 | 150 |
| | polyethylene | 3310 kPa) | | |
| | bags | | | |
| Na-ion | N-doped porous | KOH bath + Pyrolysis | 140 | 500 |
| | carbon | (800° C. for 2 hrs) | | |
| | nanosheet | | | |

It is important to note that the porous carbon derived from the sources in Table 1 were exposed to high temperature treatment (e.g., 300° C. or greater), which results in a cost penalty for the production of the material. In comparison, in the present invention, high temperature treatment was not required as the soot particles were collected by electrostatic precipitation and only baked at 250° C. As such, the present invention provides an improvement over known methods and the articles (e.g., electrodes) made by such methods.

Herein, we disclose the successful capture and reuse of diesel exhaust soot particles as a conductive additive in lithium manganese oxide (LMO) and lithium iron phosphate (LFP) cathodes in Li-ion batteries. This approach enables an abundant toxic pollutant to be converted into a valuable material for energy storage devices. This study consists of an initial characterization of the diesel soot particles, a high-temperature annealing step to remove residual organics and unburned hydrocarbons, and characterization of electrochemical performance in Li-ion battery configuration. Composite electrodes are fabricated by mixing active materials (LFP or LMO) with conductive carbon and binders. The performance of diesel soot particles as conductive additives are compared with the commercially available activated carbon (i.e., Super P®). The current evolution of the composite electrode with diesel soot particles demonstrates comparable performance with the electrode containing the Super P® carbon. Based on high-resolution transmission electron microscope (HRTEM) images and scanning mobility particle sizer (SMPS) spectra, we find that these diesel soot nanoparticles follow a narrow log-normal distribution centered around 100 nm in diameter and consist of highly porous amorphous carbon, which provide a large surface-to-volume ratio, making them ideal candidates for electrode materials in Li ion batteries. In this study, we evaluate the electrochemical performance of conductive carbon derived from diesel soot particles.

Herein, we also disclose and demonstrate the electrochemical storage capability of carbonaceous particulate matter as an anode material for Li-ion batteries.

Herein, we also disclose the electrochemical performance of soot particles derived from the combustion of diesel fuel. The morphological and chemical structure of the soot particles were characterized using SEM, XPS, and XRD analysis. The composite anode electrodes were fabricated by mixing the soot particles with conductive carbon and binder. The electrochemical behavior of the soot composite electrodes was characterized via cyclic voltammetry and impedance spectroscopy. The cycle life and rate capability of the electrode were investigated via galvanostatic cycling tests. The electrode demonstrated 150 mAh/g capacity at a 4C rate and capacity retention was almost 77% after 500 cycles. Excellent rate-capability of the soot electrode suggested pseudocapacitive charge behavior of the electrode, which was further investigated by conducting cyclic voltammetry over a wide range of scan rates and Raman spectroscopy studies.

Herein, we also disclose the electrochemical energy storage capability of annealed soot particulate matter (PM) originating from diesel exhaust. Soot composite electrodes were utilized as anode electrodes and cycled against Li counter electrodes. X-ray diffraction and Raman spectroscopy showed the graphitized carbon structure of the annealed soot particles. The cycle life and rate capability of the electrodes were investigated via galvanostatic cycling tests. The electrodes exhibited excellent rate performance with discharge capacities of 235, 195, 150, 120, and 80 mAh/g when cycled at rates of 1C, 2C, 5C, 10C, and 20C, respectively. The electrode demonstrated an initial discharge capacity of 154 mAh/g at a 4C rate with a capacity retention of almost 77% after 500 cycles. Raman analysis confirms the retention of structural ordering in the soot carbon after 500 cycles. Kinetic analysis, obtained through cyclic voltammetry at different scan rates, indicates pseudocapacitive charging behavior in the soot composite electrode. Our study provides a viable pathway towards a sustainable energy environment by converting an abundant toxic pollutant into a valuable electrode material for Li-ion batteries.

### Various Embodiments of the Invention

In various embodiments, the present invention provides an electrode for a battery, the electrode comprising an active material, wherein the active material is diesel exhaust soot particles. In some embodiments, the electrode further comprises a binder, and an electrically conductive additive.

In various embodiments, the present invention provides an electrode for a battery, the electrode comprising an active material, wherein the active material is exhaust soot from an engine. In some embodiments, the exhaust soot comprises soot particles. In some embodiments, the engine is a combustion engine. In some embodiments, the engine is an internal combustion engine. In some embodiments, the engine is selected from the group consisting of a diesel engine, jet engine, airplane engine, boat engine, ship engine, automobile engine, motor vehicle engine, gasoline engine, train engine, and combinations thereof. In some embodiments, the engine is a diesel engine.

In various embodiments, the present invention provides an electrode for a battery, the electrode comprising an active material, wherein the active material is soot from engine exhaust. In some embodiments, the soot comprises soot particles. In some embodiments, the engine exhaust is combustion engine exhaust. In some embodiments, the engine exhaust is internal combustion engine exhaust. In some embodiments, the engine exhaust is selected from the group consisting of diesel engine exhaust, jet engine exhaust, airplane engine exhaust, boat engine exhaust, ship engine exhaust, automobile engine exhaust, motor vehicle engine exhaust, gasoline engine exhaust, train engine exhaust, and combinations thereof. In some embodiments, the engine exhaust is diesel engine exhaust.

In various embodiments, the present invention provides a battery, comprising: an anode, a cathode, a separator, and an electrolyte, wherein the anode comprises an active material, and wherein the active material is diesel exhaust soot particles. In some embodiments, the anode further comprises a binder, and an electrically conductive additive.

In various embodiments, the present invention provides a battery, comprising: an anode, a cathode, a separator, and an electrolyte, wherein the anode comprises an active material, and wherein the active material is exhaust soot from an engine. In some embodiments, the exhaust soot comprises soot particles. In some embodiments, the anode further comprises a binder, and an electrically conductive additive.

In various embodiments, the present invention provides a battery, comprising: an anode, a cathode, a separator, and an electrolyte, wherein the anode comprises an active material, and wherein the active material is soot from engine exhaust. In some embodiments, the soot comprises soot particles. In some embodiments, the anode further comprises a binder, and an electrically conductive additive.

In various embodiments, the present invention provides a method of manufacturing an electrode for a battery, comprising collecting diesel exhaust soot particles; annealing the diesel exhaust soot particles; mixing the annealed diesel exhaust soot particles with a binder, water, and an electrically conductive additive to form a slurry; casting the slurry on a current collector; and drying the slurry to provide the electrode.

In various embodiments, the present invention provides a method of manufacturing an electrode for a battery, comprising collecting diesel exhaust soot; mixing the diesel exhaust soot with a binder, water, and an electrically conductive additive to form a slurry; casting the slurry on a current collector; and drying the slurry to provide the electrode. In some embodiments, the diesel exhaust soot comprises diesel exhaust soot particles.

In various embodiments, the present invention provides a method of manufacturing an electrode for a battery, comprising collecting exhaust soot from an engine, wherein the exhaust soot comprises soot particles; annealing the exhaust soot particles; mixing the annealed soot particles with a binder, water, and an electrically conductive additive to form a slurry; casting the slurry on a current collector; and drying the slurry to provide the electrode.

In various embodiments, the present invention provides a method of manufacturing an electrode for a battery, comprising collecting exhaust soot from an engine; mixing the soot with a binder, water, and an electrically conductive additive to form a slurry; casting the slurry on a current collector; and drying the slurry to provide the electrode. In some embodiments, the exhaust soot comprises soot particles.

In various embodiments, the present invention provides a method of manufacturing an electrode for a battery, comprising collecting soot from engine exhaust, wherein the soot comprises soot particles; annealing the soot particles; mixing the annealed soot particles with a binder, water, and an electrically conductive additive to form a slurry; casting the slurry on a current collector; and drying the slurry to provide the electrode.

In various embodiments, the present invention provides a method of manufacturing an electrode for a battery, comprising collecting soot from engine exhaust; mixing the soot with a binder, water, and an electrically conductive additive to form a slurry; casting the slurry on a current collector; and drying the slurry to provide the electrode. In some embodiments, the soot comprises soot particles.

In some embodiments, the binder is a polymeric binder. In some embodiments, the binder is selected from the group consisting of a carboxymethyl cellulose, carboxymethyl cellulose sodium salt, and combinations thereof. In some embodiments the binder is selected from the group consisting of carboxymethyl cellulose, carboxymethyl cellulose sodium salt, epoxy resin, and polyvinylidene fluoride (PVDF).

In some embodiments, the electrically conductive additive is a conductive carbon material.

In some embodiments, the conductive carbon material is conductive carbon black.

Non-limiting examples of conductive carbon black are Super P® conductive carbon black.

In some embodiments, the diesel exhaust soot particles are annealed. In some embodiments, the diesel exhaust soot particles are unannealed. In some embodiments, the diesel exhaust soot particles are annealed, unannealed, or a mixture of annealed and unannealed. In some embodiments, the diesel exhaust soot particles are annealed in an inert atmosphere. In some embodiments, the diesel exhaust soot particles are annealed in air.

In some embodiments, the soot particles are annealed. In some embodiments, the soot particles are unannealed. In some embodiments, the soot particles are annealed, unannealed, or a mixture of annealed and unannealed. In some embodiments, the soot particles are annealed in an inert atmosphere. In some embodiments, the soot particles are annealed in air.

In some embodiments, the diesel exhaust soot particles comprise amorphous carbon. In some embodiments, the soot particles comprise amorphous carbon. In some embodiments, the amorphous carbon is porous amorphous carbon.

In some embodiments, the electrode is an anode. In some embodiments, the electrode is a cathode. In some embodiments, the electrode is an anode electrode. In some embodiments, the electrode is a cathode electrode. In some embodiments, the electrode is a composite electrode. In some embodiments, the anode is a composite anode. In some embodiments, the anode electrode is a composite anode electrode. In some embodiments, the cathode is a composite anode. In some embodiments, the cathode electrode is a composite cathode electrode.

In some embodiments, the diesel exhaust soot particles are recycled diesel exhaust soot particles. In some embodiments, the soot particles are recycled soot particles.

In some embodiments, the diesel exhaust soot particles are about 20 nm to about 200 nm in diameter. In some embodiments, the diesel exhaust soot particles are about 20 nm to about 200 nm in diameter, about 20 nm to about 190 nm in diameter, about 20 nm to about 180 nm in diameter, about 20 nm to about 170 nm in diameter, about 20 nm to about 160 nm in diameter, about 20 nm to about 150 nm in diameter, about 20 nm to about 140 nm in diameter, about 20 nm to about 130 nm in diameter, about 20 nm to about 120 nm in diameter, about 20 nm to about 110 nm in diameter, about 20 nm to about 100 nm in diameter, about 20 nm to about 90 nm in diameter, about 20 nm to about 80 nm in diameter, about 20 nm to about 70 nm in diameter, about 20 nm to about 60 nm in diameter, about 20 nm to about 50 nm in diameter, about 20 nm to about 40 nm in diameter, or about 20 nm to about 30 nm in diameter.

In some embodiments, the soot particles are about 20 nm to about 200 nm in diameter. In some embodiments, the soot particles are about 20 nm to about 200 nm in diameter, about 20 nm to about 190 nm in diameter, about 20 nm to about 180 nm in diameter, about 20 nm to about 170 nm in diameter, about 20 nm to about 160 nm in diameter, about 20 nm to about 150 nm in diameter, about 20 nm to about 140 nm in diameter, about 20 nm to about 130 nm in diameter, about 20 nm to about 120 nm in diameter, about 20 nm to about 110 nm in diameter, about 20 nm to about 100 nm in diameter, about 20 nm to about 90 nm in diameter, about 20 nm to about 80 nm in diameter, about 20 nm to about 70 nm in diameter, about 20 nm to about 60 nm in diameter, about 20 nm to about 50 nm in diameter, about 20 nm to about 40 nm in diameter, or about 20 nm to about 30 nm in diameter.

In some embodiments, the electrode has a cycle life of about at least 500 cycles, about at least 450 cycles, about at least 400 cycles, about at least 350 cycles, about at least 300 cycles, about at least 250 cycles, about at least 200 cycles, about at least 150 cycles, about at least 100 cycles, or about at least 50 cycles. In some embodiments, the anode has a cycle life of about at least 500 cycles, about at least 450 cycles, about at least 400 cycles, about at least 350 cycles, about at least 300 cycles, about at least 250 cycles, about at least 200 cycles, about at least 150 cycles, about at least 100 cycles, or about at least 50 cycles. In some embodiments, the anode electrode has a cycle life of about at least 500 cycles, about at least 450 cycles, about at least 400 cycles, about at least 350 cycles, about at least 300 cycles, about at least 250 cycles, about at least 200 cycles, about at least 150 cycles, about at least 100 cycles, or about at least 50 cycles.

In some embodiments, the electrode has a cycle life of about 500 cycles to about 50 cycles, about 500 cycles to about 100 cycles, about 500 cycles to about 150 cycles, about 500 cycles to about 200 cycles, about 500 cycles to about 250 cycles, about 500 cycles to about 300 cycles, about 500 cycles to about 350 cycles, about 500 cycles to about 400 cycles, or about 500 cycles to about 450 cycles. In some embodiments, the anode electrode has a cycle life of about 500 cycles to about 50 cycles, about 500 cycles to about 100 cycles, about 500 cycles to about 150 cycles, about 500 cycles to about 200 cycles, about 500 cycles to about 250 cycles, about 500 cycles to about 300 cycles, about 500 cycles to about 350 cycles, about 500 cycles to about 400 cycles, or about 500 cycles to about 450 cycles. In some embodiments, the anode has a cycle life of about 500 cycles to about 50 cycles, about 500 cycles to about 100 cycles, about 500 cycles to about 150 cycles, about 500 cycles to about 200 cycles, about 500 cycles to about 250 cycles, about 500 cycles to about 300 cycles, about 500 cycles to about 350 cycles, about 500 cycles to about 400 cycles, or about 500 cycles to about 450 cycles.

In some embodiments, the battery is capable of being charged in a time period, wherein the time period is 3 minutes to 60 minutes. In some embodiments, the battery is capable of being charged in a time period, wherein the time period is 3 minutes to 55 minutes, 3 minutes to 50 minutes, 3 minutes to 45 minutes, 3 minutes to 40 minutes, 3 minutes to 35 minutes, 3 minutes to 30 minutes, 3 minutes to 25 minutes, 3 minutes to 20 minutes, 3 minutes to 15 minutes, 3 minutes to 10 minutes, or 3 minutes to 5 minutes. In some embodiments, the battery is capable of being charged in a time period, wherein the time period is at least 3 minutes, at least 5 minutes, at least 10 minutes, at least 15 minutes, at least 20 minutes, at least 25 minutes, at least 30 minutes, at least 35 minutes, at least 40 minutes, at least 45 minutes, at least 50 minutes, at least 55 minutes, or at least 60 minutes.

In some embodiments, the diesel exhaust soot particles are annealed at a temperature from 100° C. to 250° C. for 1 hour to 4 hours. In some embodiments, the diesel exhaust soot particles are annealed at a temperature from 100° C. to 250° C., 100° C. to 240° C., 100° C. to 230° C., 100° C. to 220° C., 100° C. to 210° C., 100° C. to 200° C., 100° C. to 190° C., 100° C. to 180° C., 100° C. to 170° C., 100° C. to 160° C., 100° C. to 150° C., 100° C. to 140° C., 100° C. to 130° C., or 100° C. to 120° C. In some embodiments, the diesel exhaust soot particles are annealed for 1 hour to 4 hours. In some embodiments, the diesel exhaust soot particles are annealed for 60 minutes to 240 minutes, 60 minutes to 210 minutes, 60 minutes to 180 minutes, 60 minutes to 150 minutes, 60 minutes to 120 minutes, or 60 minutes to 90 minutes.

In some embodiments, the soot particles are annealed at a temperature from 100° C. to 250° C. for 1 hour to 4 hours. In some embodiments, the soot particles are annealed at a temperature from 100° C. to 250° C., 100° C. to 240° C., 100° C. to 230° C., 100° C. to 220° C., 100° C. to 210° C., 100° C. to 200° C., 100° C. to 190° C., 100° C. to 180° C., 100° C. to 170° C., 100° C. to 160° C., 100° C. to 150° C., 100° C. to 140° C., 100° C. to 130° C., or 100° C. to 120° C. In some embodiments, the soot particles are annealed for 1 hour to 4 hours. In some embodiments, the soot particles are annealed for 60 minutes to 240 minutes, 60 minutes to 210 minutes, 60 minutes to 180 minutes, 60 minutes to 150 minutes, 60 minutes to 120 minutes, or 60 minutes to 90 minutes.

In some embodiments, the diesel exhaust soot particles are collected from diesel exhaust soot. In some embodiments, the diesel exhaust soot particles are collected from diesel exhaust soot using electrostatic precipitation.

In some embodiments, the soot particles are collected from exhaust soot from an engine. In some embodiments, the soot particles are collected from exhaust soot from an engine using electrostatic precipitation.

In some embodiments, the soot particles are collected from soot from engine exhaust. In some embodiments, the soot particles are collected from soot from engine exhaust using electrostatic precipitation.

In some embodiments, the electrode is capable of storing and discharging ions, wherein the ions are selected from the group consisting of lithium ions, sodium ions, potassium ions, and combinations thereof. In some embodiments, the electrode is capable of storing and discharging ions, wherein the ions are selected from the group consisting of lithium ions, sodium ions, and combinations thereof. In some embodiments, the electrode is capable of storing and discharging lithium ions. In some embodiments, the electrode is capable of storing and discharging sodium ions. In some embodiments, the electrode is capable of storing and discharging potassium ions.

In some embodiments, the anode is capable of storing and discharging ions, wherein the ions are selected from the group consisting of lithium ions, sodium ions, potassium ions, and combinations thereof. In some embodiments, the anode is capable of storing and discharging ions, wherein the ions are selected from the group consisting of lithium ions, sodium ions, and combinations thereof. In some embodiments, the anode is capable of storing and discharging lithium ions. In some embodiments, the anode is capable of storing and discharging sodium ions. In some embodiments, the anode is capable of storing and discharging potassium ions.

In some embodiments, the electrode is capable of pseudocapacitive charging. In some embodiments, the battery is capable of pseudocapacitive charging. In some embodiments, the anode is capable of pseudocapacitive charging. In some embodiments, the anode electrode is capable of pseudocapacitive charging.

In some embodiments, the battery is selected from the group consisting of a lithium ion battery, a sodium ion battery, potassium ion battery, and combinations thereof. In some embodiments, the battery is selected from the group consisting of a lithium ion battery, a sodium ion battery, and combinations thereof. In some embodiments, the battery is a lithium ion battery. In some embodiments, the battery is a sodium ion battery. In some embodiments, the battery is a potassium ion battery.

In some embodiments, the battery is selected from the group consisting of a rechargeable lithium ion battery, a rechargeable sodium ion battery, rechargeable potassium ion battery, and combinations thereof. In some embodiments, the battery is selected from the group consisting of a rechargeable lithium ion battery, a rechargeable sodium ion battery, and combinations thereof. In some embodiments, the battery is a rechargeable lithium ion battery. In some embodiments, the battery is a rechargeable sodium ion battery. In some embodiments, the battery is a rechargeable potassium ion battery.

In some embodiments, the battery is capable of storing and discharging ions, wherein the ions are selected from the group consisting of lithium ions, sodium ions, potassium ions, and combinations thereof. In some embodiments, the battery is capable of storing and discharging ions, wherein the ions are selected from the group consisting of lithium ions, sodium ions, and combinations thereof. In some embodiments, the battery is capable of storing and discharging lithium ions. In some embodiments, the battery is capable of storing and discharging sodium ions. In some embodiments, the battery is capable of storing and discharging potassium ions.

In various embodiments, the present invention provides an electrode material for a lithium ion battery, comprising: diesel exhaust soot particles. In some embodiments, the lithium ion battery is a rechargeable lithium ion battery. In some embodiments, the electrode material for a lithium ion battery further comprises a binder, and at least one selected from the group consisting of lithium manganese oxide (LMO) and lithium iron phosphate (LFP). In some embodiments, the electrode material is a composite electrode material. In some embodiments, the diesel exhaust soot particles are about 20 nm to about 200 nm in diameter. In some embodiments, the diesel exhaust soot particles comprise amorphous carbon. In some embodiments, the amorphous carbon is porous amorphous carbon. In some embodiments, the diesel exhaust soot particles are annealed. In some embodiments, the diesel exhaust soot particles are recycled diesel exhaust soot particles. In various embodiments, the present invention provides for use of an electrode material for a lithium ion battery, comprising: diesel exhaust soot particles.

In various embodiments, the present invention provides a lithium ion battery electrode, comprising: diesel exhaust soot particles. In some embodiments, the lithium battery electrode further comprises a binder, and at least one selected from the group consisting of lithium manganese oxide (LMO) and lithium iron phosphate (LFP). In some embodiments, the electrode is a composite electrode. In some embodiments, the diesel exhaust soot particles are about 20 nm to about 200 nm in diameter. In some embodiments, the diesel exhaust soot particles comprise amorphous carbon. In some embodiments, the amorphous carbon is porous amorphous carbon. In some embodiments, the diesel exhaust soot particles are annealed. In some embodiments, the diesel exhaust soot particles are recycled diesel exhaust soot particles.

In various embodiments, the present invention provides a lithium ion battery, comprising: diesel exhaust soot particles. In some embodiments, the lithium ion battery is rechargeable. In some embodiments, the diesel exhaust soot particles are about 20 nm to about 200 nm in diameter. In some embodiments, the diesel exhaust soot particles comprise amorphous carbon. In some embodiments, the amorphous carbon is porous amorphous carbon. In some embodiments, the diesel exhaust soot particles are annealed. In some embodiments, the diesel exhaust soot particles are recycled diesel exhaust soot particles.

In various embodiments, the present invention provides a lithium ion battery, comprising a first electrode; a second electrode; and an electrolyte, wherein the second electrode comprises diesel exhaust soot particles. In some embodiments, the lithium ion battery is rechargeable. In some embodiments, the diesel exhaust soot particles are about 20 nm to about 200 nm in diameter. In some embodiments, the diesel exhaust soot particles comprise amorphous carbon. In some embodiments, the amorphous carbon is porous amorphous carbon. In some embodiments, the diesel exhaust soot particles are annealed. In some embodiments, the diesel exhaust soot particles are recycled diesel exhaust soot particles.

In various embodiments, the present invention provides a method of manufacturing activated carbon for a lithium ion battery electrode, the method comprising: collecting diesel exhaust soot particles; and annealing the diesel exhaust soot particles.

In various embodiments, the present invention provides a method of manufacturing an electrode material for a lithium ion battery, comprising: collecting diesel exhaust soot particles; annealing the diesel exhaust soot particles to form activated carbon; mixing the activated carbon with a binder, water, and at least one selected from the group consisting of lithium manganese oxide (LMO) and lithium iron phosphate (LFP) to form a slurry; and drying the slurry.

In various embodiments, the present invention provides a method of manufacturing an electrode for a lithium ion battery, comprising: collecting diesel exhaust soot particles; annealing the diesel exhaust soot particles to form activated carbon; mixing the activated carbon with a binder, water, and at least one selected from the group consisting of lithium manganese oxide (LMO) and lithium iron phosphate (LFP) to form a slurry; casting the slurry on a current collector; and drying the slurry.

In various embodiments, the present invention provides a lithium ion battery electrode, comprising: an active material, a conductive additive, and a binder, wherein the conductive additive comprises diesel exhaust soot particles. In some embodiments the active material is selected from the group consisting of lithium iron phosphate (LFP), lithium manganese oxide (LMO), lithium cobalt oxide (LCO), and lithium nickel manganese cobalt oxide (NMC). In some embodiments, the binder is a polymer. In some embodiments, the diesel exhaust soot particles are about 20 nm to about 200 nm in diameter. In some embodiments, the diesel exhaust soot particles are annealed.

Some embodiments of the present invention can be defined as any of the following numbered paragraphs:
1. An electrode material for a lithium ion battery, comprising: diesel exhaust soot particles.
2. The electrode material of paragraph 1, wherein the lithium ion battery is a rechargeable lithium ion battery.
3. The electrode material of paragraph 1, further comprising a binder, and at least one selected from the group consisting of lithium manganese oxide (LMO) and lithium iron phosphate (LFP).
4. The electrode material of paragraph 1, wherein the electrode material is a composite electrode material.
5. The electrode material of paragraph 1, wherein the diesel exhaust soot particles are about 20 nm to about 200 nm in diameter.
6. The electrode material of paragraph 1, wherein the diesel exhaust soot particles comprise amorphous carbon.
7. The electrode material of paragraph 6, wherein the amorphous carbon is porous amorphous carbon.
8. The electrode material of paragraph 1, wherein the diesel exhaust soot particles are annealed.
9. The electrode material of paragraph 1, wherein the diesel exhaust soot particles are recycled diesel exhaust soot particles.
10. Use of an electrode material in accordance with paragraph 1 as an electrode material in a lithium ion battery.
11. A lithium ion battery electrode, comprising: diesel exhaust soot particles.
12. The lithium ion battery electrode of paragraph 11, further comprising a binder, and at least one selected from the group consisting of lithium manganese oxide (LMO) and lithium iron phosphate (LFP).
13. The lithium ion battery electrode of paragraph 11, wherein the electrode is a composite electrode.
14. The lithium ion battery electrode of paragraph 11, wherein the diesel exhaust soot particles are about 20 nm to about 200 nm in diameter.
15. The lithium ion battery electrode of paragraph 11, wherein the diesel exhaust soot particles comprise amorphous carbon.
16. The lithium ion battery electrode of paragraph 15, wherein the amorphous carbon is porous amorphous carbon.
17. The lithium ion battery electrode of paragraph 11, wherein the diesel exhaust soot particles are annealed.
18. The lithium ion battery electrode of paragraph 11, wherein the diesel exhaust soot particles are recycled diesel exhaust soot particles.
19. A lithium ion battery, comprising: diesel exhaust soot particles.
20. The lithium ion battery of paragraph 19, wherein the lithium ion battery is rechargeable.
21. The lithium ion battery of paragraph 19, wherein the diesel exhaust soot particles are about 20 nm to about 200 nm in diameter.
22. The lithium ion battery of paragraph 19, wherein the diesel exhaust soot particles comprise amorphous carbon.
23. The lithium ion battery of paragraph 22, wherein the amorphous carbon is porous amorphous carbon.
24. The lithium ion battery of paragraph 19, wherein the diesel exhaust soot particles are annealed.
25. The lithium ion battery of paragraph 19, wherein the diesel exhaust soot particles are recycled diesel exhaust soot particles.
26. A lithium ion battery, comprising: a first electrode; a second electrode; and an electrolyte, wherein the second electrode comprises diesel exhaust soot particles.
27. The lithium ion battery of paragraph 26, wherein the lithium ion battery is rechargeable.
28. The lithium ion battery of paragraph 26, wherein the diesel exhaust soot particles are about 20 nm to about 200 nm in diameter.
29. The lithium ion battery of paragraph 26, wherein the diesel exhaust soot particles comprise amorphous carbon.
30. The lithium ion battery of paragraph 29, wherein the amorphous carbon is porous amorphous carbon.
31. The lithium ion battery of paragraph 26, wherein the diesel exhaust soot particles are annealed.
32. The lithium ion battery of paragraph 26, wherein the diesel exhaust soot particles are recycled diesel exhaust soot particles.
33. A method of manufacturing activated carbon for a lithium ion battery electrode, the method comprising: collecting diesel exhaust soot particles; and annealing the diesel exhaust soot particles.
34. A method of manufacturing an electrode material for a lithium ion battery, comprising: collecting diesel exhaust soot particles; annealing the diesel exhaust soot particles to form activated carbon; mixing the activated carbon with a binder, water, and at least one selected from the group consisting of lithium manganese oxide (LMO) and lithium iron phosphate (LFP) to form a slurry; and drying the slurry.
35. A method of manufacturing an electrode for a lithium ion battery, comprising: collecting diesel exhaust soot particles; annealing the diesel exhaust soot particles to form activated carbon;
mixing the activated carbon with a binder, water, and at least one selected from the group consisting of lithium manganese oxide (LMO) and lithium iron phosphate (LFP) to form a slurry; casting the slurry on a current collector; and drying the slurry.

Some embodiments of the present invention can be defined as any of the following numbered paragraphs:
36. An electrode for a battery, the electrode comprising an active material, wherein the active material is diesel exhaust soot particles.
37. The electrode of paragraph 36, wherein the electrode further comprises a binder, and an electrically conductive additive.
38. The electrode of paragraph 37, wherein the binder is a polymeric binder.
39. The electrode of paragraph 37, wherein the binder is selected from the group consisting of a carboxymethyl cellulose, carboxymethyl cellulose sodium salt, and combinations thereof.
40. The electrode of paragraph 37, wherein the electrically conductive additive is a conductive carbon material.
41. The electrode of paragraph 40, wherein the conductive carbon material is conductive carbon black.
42. The electrode of paragraph 36, wherein the diesel exhaust soot particles are annealed.
43. The electrode of paragraph 36, wherein the diesel exhaust soot particles comprise amorphous carbon.
44. The electrode of paragraph 43, wherein the amorphous carbon is porous amorphous carbon.
45. The electrode of paragraph 36, wherein the electrode is a composite electrode.
46. The electrode of paragraph 36, wherein the diesel exhaust soot particles are recycled diesel exhaust soot particles.
47. The electrode of paragraph 36, wherein the diesel exhaust soot particles are about 20 nm to about 200 nm in diameter.
48. The electrode of paragraph 36, wherein the electrode has a cycle life of at least about 500 cycles.
49. The electrode of paragraph 36, wherein the electrode is capable of pseudocapacitive charging.
50. The electrode of paragraph 36, wherein the electrode is an anode electrode.
51. The electrode of paragraph 36, wherein the electrode is capable of storing and discharging ions, wherein the ions are selected from the group consisting of lithium ions, sodium ions, potassium ions, and combinations thereof.
52. The electrode of paragraph 36, wherein the battery is capable of being charged in a time period, wherein the time period is selected from 3 minutes to 60 minutes.
53. The electrode of paragraph 36, wherein the battery is selected from the group consisting of a lithium ion battery, a sodium ion battery, a potassium ion battery, and combinations thereof.
54. The electrode of paragraph 36, wherein the battery is selected from the group consisting of a rechargeable lithium ion battery, a rechargeable sodium ion battery, a rechargeable potassium ion battery, and combinations thereof.
55. The electrode of paragraph 36, wherein the battery is capable of storing and discharging ions, wherein the ions are selected from the group consisting of lithium ions, sodium ions, potassium ions, and combinations thereof.
56. The electrode of paragraph 36, wherein the battery is capable of pseudocapacitive charging.
57. A battery, comprising: an anode, a cathode, a separator, and an electrolyte, wherein the anode comprises an active material, and wherein the active material is diesel exhaust soot particles.
58. The battery of paragraph 57, wherein the anode further comprises a binder, and an electrically conductive additive.
59. The battery of paragraph 58, wherein the binder is a polymeric binder.
60. The battery of paragraph 58, wherein the binder is selected from the group consisting of a carboxymethyl cellulose, carboxymethyl cellulose sodium salt, and combinations thereof.
61. The battery of paragraph 58, wherein the electrically conductive additive is a conductive carbon material.
62. The battery of paragraph 61, wherein the conductive carbon material is conductive carbon black.
63. The battery of paragraph 57, wherein the diesel exhaust soot particles are annealed.
64. The battery of paragraph 57, wherein the diesel exhaust soot particles comprise amorphous carbon.
65. The battery of paragraph 64, wherein the amorphous carbon is porous amorphous carbon.
66. The battery of paragraph 57, wherein the anode is a composite anode.
67. The battery of paragraph 57, wherein the diesel exhaust soot particles are recycled diesel exhaust soot particles.
68. The battery of paragraph 57, wherein the diesel exhaust soot particles are about 20 nm to about 200 nm in diameter.
69. The battery of paragraph 57, wherein the anode has a cycle life of at least about 500 cycles.
70. The battery of paragraph 57, wherein the anode is capable of storing and discharging ions, wherein the ions are selected from the group consisting of lithium ions, sodium ions, potassium ions, and combinations thereof.
71. The battery of paragraph 57, wherein the anode is capable of pseudocapacitive charging.
72. The battery of paragraph 57, wherein the battery is capable of being charged in a time period, wherein the time period is selected from 3 minutes to 60 minutes.
73. The battery of paragraph 57, wherein the battery is selected from the group consisting of a lithium ion battery, a sodium ion battery, potassium ion battery, and combinations thereof.
74. The battery of paragraph 57, wherein the battery is selected from the group consisting of a rechargeable lithium ion battery, a rechargeable sodium ion battery, rechargeable potassium ion battery, and combinations thereof.
75. The battery of paragraph 57, wherein the battery is capable of storing and discharging ions, wherein the ions are selected from the group consisting of lithium ions, sodium ions, potassium ions, and combinations thereof.
76. The battery of paragraph 57, wherein the battery is capable of pseudocapacitive charging.
77. A method of manufacturing an electrode for a battery, comprising: collecting diesel exhaust soot particles; annealing the diesel exhaust soot particles; mixing the annealed diesel exhaust soot particles with a binder, water, and an electrically conductive additive to form a slurry; casting the slurry on a current collector; and drying the slurry to provide the electrode.
78. The method of paragraph 77, wherein the binder is a polymeric binder.
79. The method of paragraph 77, wherein the binder is selected from the group consisting of a carboxymethyl cellulose, carboxymethyl cellulose sodium salt, and combinations thereof.
80. The method of paragraph 77, wherein the electrically conductive additive is a conductive carbon material.
81. The method of paragraph 80, wherein the conductive carbon material is conductive carbon black.
82. The method of paragraph 77, wherein the diesel exhaust soot particles are collected from diesel exhaust soot.
83. The method of paragraph 77, wherein the diesel exhaust soot particles are collected from diesel exhaust soot using electrostatic precipitation.
84. The method of paragraph 77, wherein the diesel exhaust soot particles are about 20 nm to about 200 nm in diameter.
85. The method of paragraph 77, wherein the diesel exhaust soot particles comprise amorphous carbon.
86. The method of paragraph 85, wherein the amorphous carbon is porous amorphous carbon.
87. The method of paragraph 77, wherein the electrode is a composite electrode.
88. The method of paragraph 77, wherein the electrode is capable of storing and discharging ions, wherein the ions are selected from the group consisting of lithium ions, sodium ions, potassium ions, and combinations thereof.
89. The method of paragraph 77, wherein the electrode is capable of pseudocapacitive charging.
90. The method of paragraph 77, wherein the diesel exhaust soot particles are annealed at a temperature from 100° C. to 250° C. for 1 hour to 4 hours.
91. The method of paragraph 77, wherein the battery is selected from the group consisting of a lithium ion battery, a sodium ion battery, potassium ion battery, and combinations thereof.
92. The method of paragraph 77, wherein the battery is selected from the group consisting of a rechargeable lithium ion battery, a rechargeable sodium ion battery, a rechargeable potassium ion battery, and combinations thereof.
93. The method of paragraph 77, wherein the battery is capable of storing and discharging ions, wherein the ions are selected from the group consisting of lithium ions, sodium ions, potassium ions, and combinations thereof.
94. The method of paragraph 77, wherein the battery is capable of pseudocapacitive charging.

### EXAMPLES

The invention is further illustrated by the following examples which are intended to be purely exemplary of the invention, and which should not be construed as limiting the invention in any way. The following examples are illustrative only, and are not intended to limit, in any manner, any of the aspects described herein. The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

### Example 1

Materials and Methods

Here, we present a proof-of-concept study demonstrating the successful conversion of diesel engine exhaust soot particles to a high-surface area electrode material for rechargeable Li ion batteries. We characterize the size and shape of these using HRTEM and SMPS, and then anneal the material in a pretreatment step before building a coin-cell lithium ion battery using this material. In this controlled study, the performance of commercially available activated carbon material is compared to pre-annealed and post-annealed diesel soot material. We characterize the current-voltage characteristics as well as the charging/discharging performance of these three prototype LMO or LFP composite electrodes.

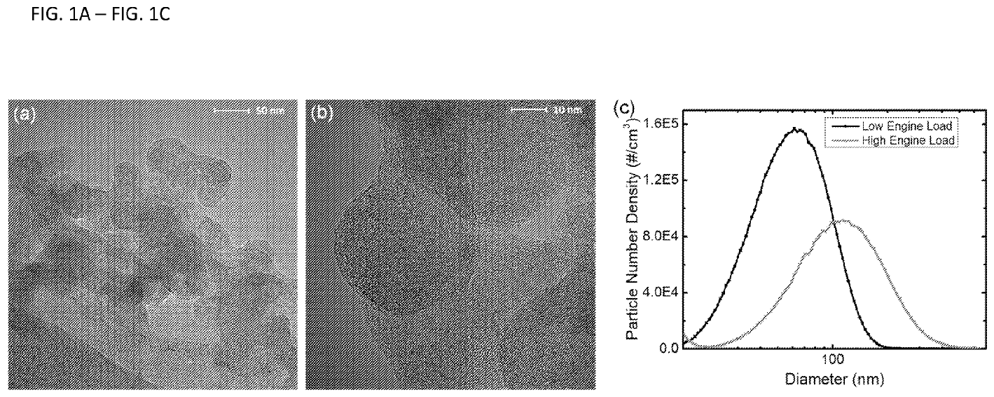

In our experimental setup, diesel soot particles are collected and then deposited on TEM-compatible substrates. The particle size, shape, and clustering are characterized using high-resolution transmission electron microscopy (HRTEM). FIG. 1A-FIG. 1C shows HRTEM images of nanoparticle size distributions in the 20-200 nm diameter range, as measured using a scanning mobility particle sizer (SMPS) spectrometer. These particulates are then annealed at 250° C. in air for 4 hours in order to purify them for use as activated carbon.

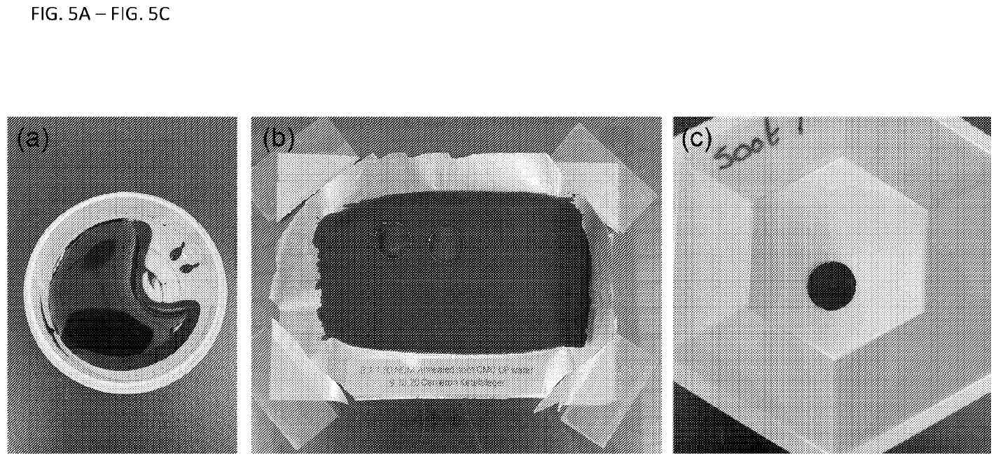

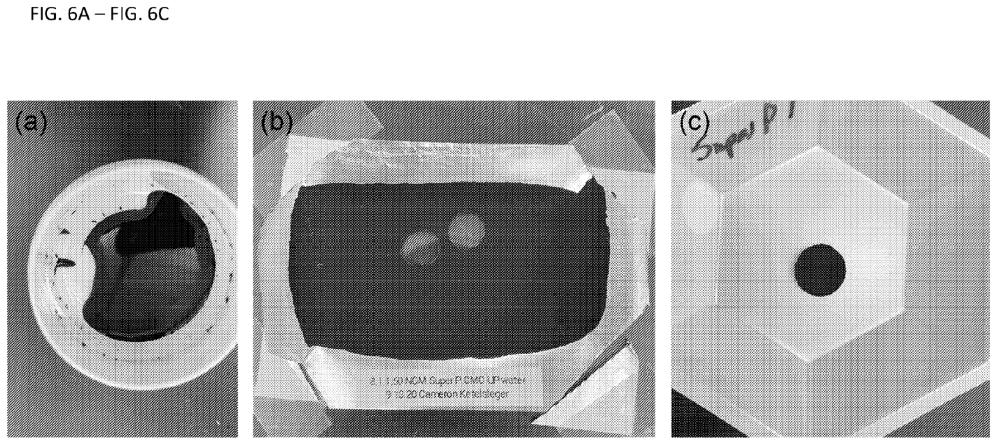

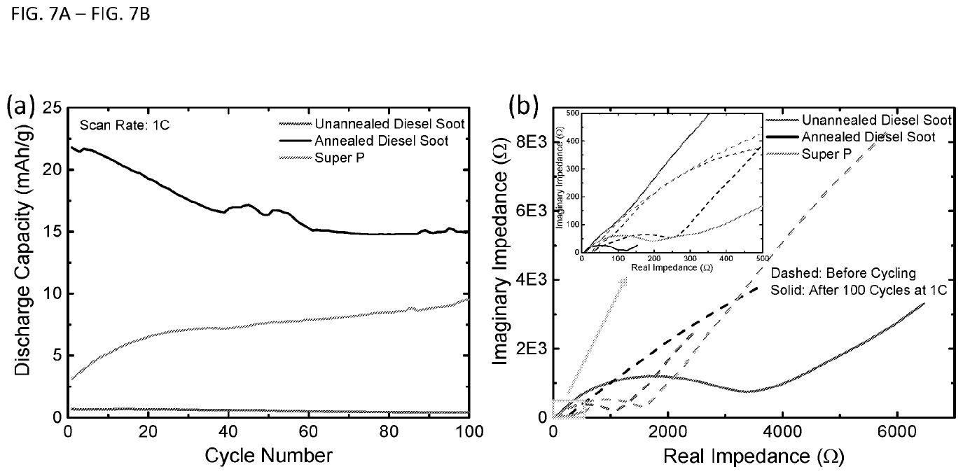

Composite electrodes were fabricated to characterize the electrochemical performance of the activated carbons. The composite electrodes were made by combining lithium manganese oxide (LiMn₂O₄, LMO, electrochemical grade, Sigma Aldrich) or lithium iron phosphate (LiFePO₄, LFP) with carboxymethyl cellulose sodium salt binder (CMC, Aldrich) and conductive carbon additives in an 8:1:1 mass ratio. The LMO and LFP powders were used as-is, and their particle size is around 3 micron and 250 nm, respectively. Conductive carbons were either commercially available Super P® carbon (Timcal), annealed or unannealed soot material. The CMC polymer binder was dissolved in deionized water in a 1:50 weight ratio. The prescribed amount of LMO or LFP and conductive carbon additives were added to the binder solution. The slurry was mixed for 30 minutes using a Thinky centrifugal mixer at 2000 RPM. FIG. 5A-FIG. 5C and FIG. 6A-FIG. 6C show pictures of the electrode manufacturing steps. The slurry was cast on an aluminum foil current collector using a doctor blade and dried under room conditions. The electrolyte for all electrochemical testing consisted of ethylene carbonate (EC, Anhydrous, 99%, Sigma Aldrich) and dimethyl carbonate (DMC, Anhydrous, >99%, Sigma Aldrich) at a 1:1 volume ratio. After that, 1 M LiPF₆ (98%, Sigma Aldrich) was added to the EC:DMC solution. The electrolyte was mixed with a magnetic stirrer in a glove box for one day. A CR2032 coin-cell was fabricated consisted of an LMO or LFP composite cathode as the working electrode, lithium metal anode as the counter electrode, and Celgard polyethylene film as the separator. The composite electrodes were cycled either via cycling voltammetry at 50 μV/sec or galvanostatically at different C-rates.

### Results and Discussion

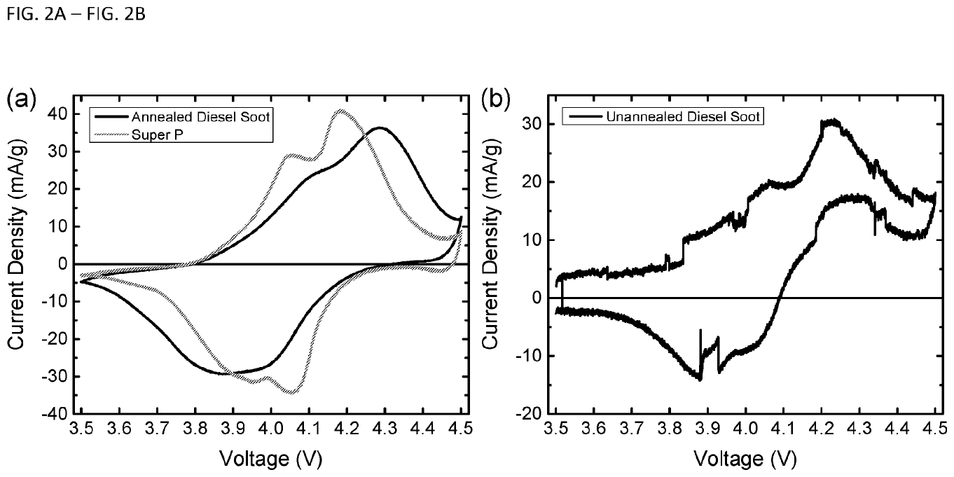

FIG. 2A shows the current density evolution of composite LMO electrodes prepared with different conductive additives plotted as a function of voltage during the 5th cycle at 50 μV/sec. As expected, two distinct current peaks are clearly observed during delithiation and lithiation in the Super P®-containing electrode. These current peaks correspond to the well-known two-phase transformation in the LMO electrode structure. Two pairs of oxidation/reduction peaks in the annealed soot-containing electrode indicate that there is no additional redox reaction associated with the annealed soot particles. The current peaks for annealed soot particle containing electrode precede the current peaks for the Super P® containing electrode by ca. 0.1 V during and after delithiation. The interval between the oxidation and the corresponding reduction potentials are also greater for the annealed soot particle-containing electrode, indicating that there is polarization within the electrode due to the larger resistance in the annealed soot particle containing electrode. While the annealed soot particles demonstrate larger resistance in the electrode, the maximum current density observed in the annealed soot particle-electrode is similar to that of the Super P®-containing electrode. The capacity of the electrode is calculated by taking the integral of current with time. The charge/discharge capacity for the LMO electrode containing Super P® carbon and annealed soot particles were around 70 mAh/g. The theoretical capacity of the LMO electrode is 148 mAh/g. FIG. 2B shows the current evolution of the electrode prepared with unannealed soot particles. Less distinct current peaks with lower current density values are observed in the unannealed soot particle-containing electrode, which exhibits highly unstable current responses in cyclic voltammetry.

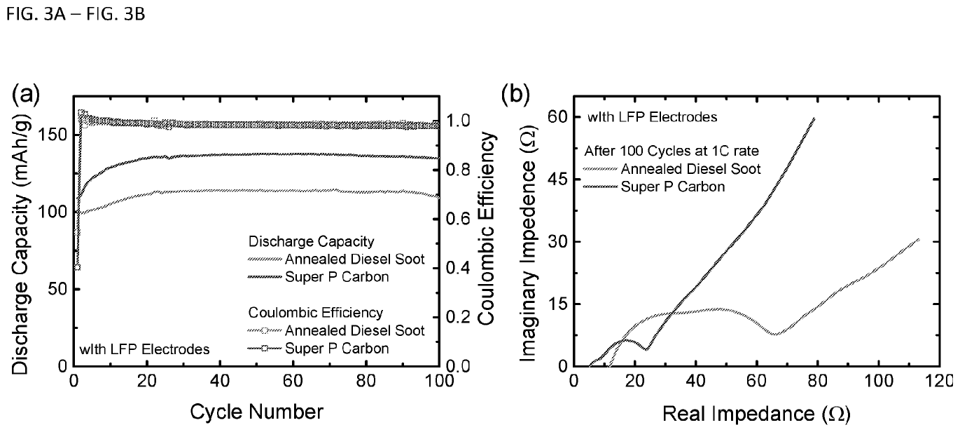

FIG. 3A shows the discharging capacity of the LFP composite electrodes cycled 100 times at 1C rate. The initial discharge capacities of the electrode containing the Super P® carbon and annealed soot carbon were 92.2 and 108.7 mAh/g, respectively. The discharge capacity of the electrode containing the Super P® carbon and annealed soot carbon became 134.9 and 98.3 mAh/g after 100 cycles, respectively. The Coulombic efficiency for LFP containing Super P® carbon and annealed soot carbon after 100 cycles was 97.9% and 98.2%, respectively. Electrochemical impedance spectroscopy (EIS) of the composite electrodes containing different conductive carbons was performed before and after cycling with a sinusoidal amplitude of 5 mV from 100 kHz to 10 MHz, as shown in FIG. 3B. EIS measurements were conducted using Biologic potentiostat equipped with acquisition software EC-EC-Lab®. The high-to-mid frequency region obtained from EIS is represented as Nyquist plots with real (Z′) and imaginary (−Z′) parts of the impedance plotted on the x- and y-axes, respectively. The radius of the semicircle at high frequency (low Z′) can be associated with the charge transfer resistance of the electrode. Before cycling, the charge transfer resistance of electrodes containing the annealed soot carbon and is much lower than the electrode containing Super P® carbon. Since impedance measurements are highly sensitive to the surface area, it is more informative to compare the change in electrode resistance with cycling. Overall, electrochemical resistance decreased with cycling in all electrodes. The electrodes containing Super P® carbon exhibit a decrease in impedance with cycling. In the case of the annealed carbon soot, the electrode resistance decreased with cycling.

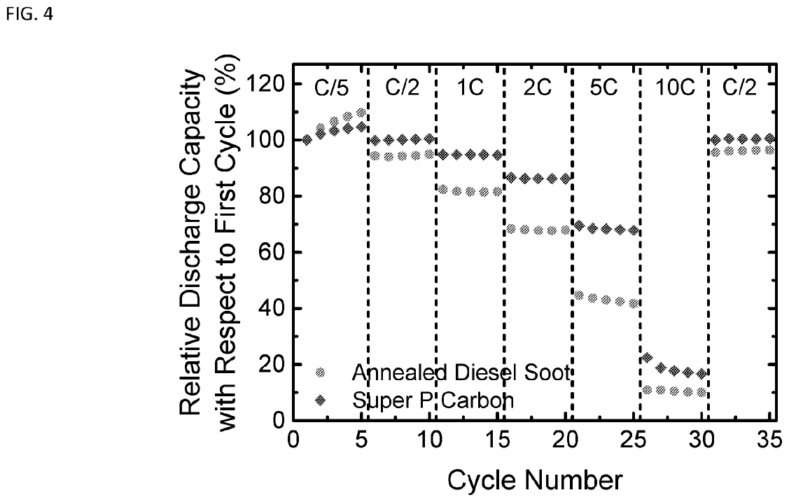

The impact of the scan rates on the discharge capacity was also tested for LFP electrodes containing Super P® carbon and annealed soot carbon, as plotted in FIG. 4. The initial capacity at C/5 rate was 112 and 140 mAh/g for the electrode containing annealed soot carbon and Super P® carbon, respectively. The discharge capacity decreased when the electrode was charged at faster rates regardless of the conductive carbon. When the rate is set back to C/2, the relative capacity become 99.9% and 95.5% with respect to the first cycle for electrode containing annealed soot carbon and Super P® carbon, respectively.

In conclusion, we demonstrate that diesel exhaust soot particles can be recycled and used as activated carbon in Li ion batteries. Here, an abundant carcinogenic pollutant is converted into a value-add material that can be used in Li ion energy storage devices. The diesel soot nanoparticles follow a log-normal distribution centered around 100 nm, as characterized by electron microscopy and scanning mobility particle sizer spectroscopy. Once collected, high-temperature annealing is used to remove residual organics and unburned hydrocarbons from the diesel soot particles. Composite LFP and LMO electrodes containing the recycled material performs competitive with the commercially available activated carbon (i.e., Super P®) typically used in Li ion batteries. The unannealed diesel soot particulate material, however, performs much worse than the annealed material with highly unstable current-voltage characteristics and low discharging capacities. These diesel soot particulates consist of highly porous amorphous carbon, which provide a large surface-to-volume ratio, making them ideal candidates for electrode materials in Li ion batteries.

### Example 2

Materials and Methods

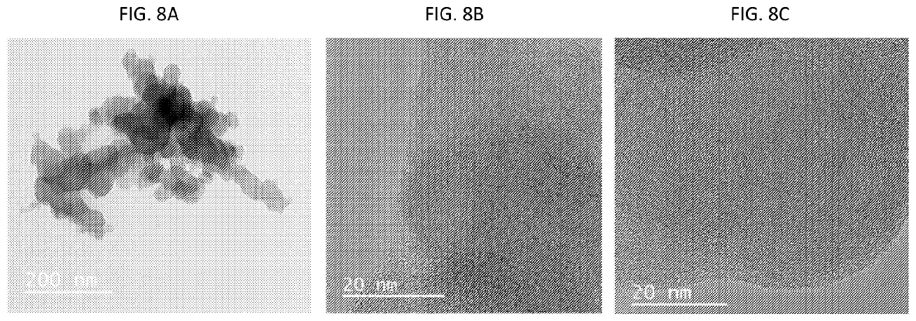

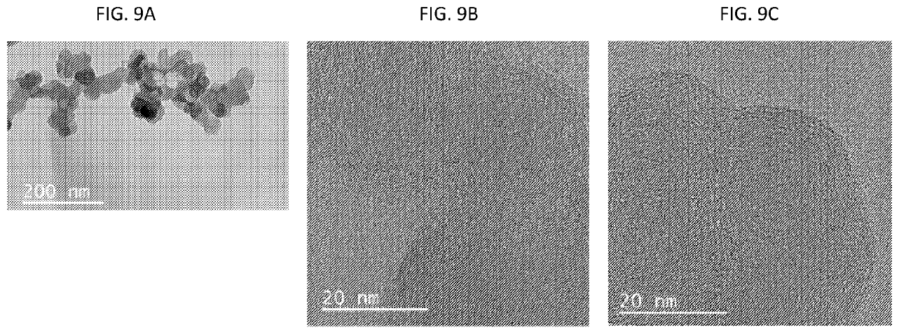

Recycled Particulate Matter: The details of the preparation of the soot particles are provided above herein. Briefly, soot particles were collected from diesel engine exhaust using electrostatic precipitation. The electrostatic precipitation of soot is highly energy efficient and requires less than 1% of the engine power. The preparation of soot anode material consists primarily of low-temperature annealing that could potentially be carried out using various waste heat sources. The collected particles were then annealed at 250° C. in the argon environment for 4 hours. We performed high resolution transmission electron microscopy (HRTEM) imaging of the unannealed (FIG. 8A-FIG. 8C) and annealed (FIG. 9A-FIG. 9C). Both samples show crystal lattice fringes corresponding to roughly 3.4 Å spacing, indicating graphitic structure. According to these images, there is no apparent difference in the material structure with and without annealing. Therefore, without being bound by theory, we believe that this annealing step simply removes some of the more volatile organic contaminants.

Electrode Fabrication: Annealed diesel soot particles were used as the active material in composite electrodes for electrochemical characterizations. The composite electrodes were fabricated by mixing the annealed soot particles with carboxymethyl cellulose sodium salt binder (CMC, Aldrich) and Super P® conductive carbon additive (Alfa Aesar) in an 8:1:1 mass ratio, respectively. First, the CMC binder was dissolved in ultrapure water and mixed for 10 min in a Thinky centrifugal mixer at 2000 rpm mixing speed. Next, the annealed soot particles and Super P® conductive carbon were added to the binder mixture. The resulting slurry was mixed in a Thinky centrifugal mixer at 2000 rpm for 30 minutes. The slurry was then cast onto Cu foil (9 μm thick, >99.99%, MTI) using a doctor blade.

Electrochemical Cycling: CR2032 coin cells were assembled using the composite electrode as a working electrode, Li foil (99.9% metal basis, Alfa Aesar) as a counter electrode, and Celgard polyethylene film as a separator. The electrolyte was prepared by dissolving 1 M LiClO₄ in 1:1 (v:v) ethylene carbonate (EC, anhydrous, 99%, Sigma Aldrich): dimethyl carbonate (DMC, anhydrous, >99%, Sigma Aldrich). Coin cell assembly and electrolyte preparation were both performed in a glovebox under an inert argon atmosphere with moisture and oxygen levels kept below 1.5 ppm. Galvanostatic cycling and cyclic voltammetry tests were conducted between 2.0 to 0.01 V vs Li^{+/0} on an Arbin potentiostat/galvanostat (MSTAT21044). Lithiation refers to the insertion of Li⁺ ions into the composite electrode during the discharge cycle, and delithiation refers to the extraction of Li⁺ ions from the composite electrode during the charge cycle.

During galvanostatic cycling, a constant current, I, is applied until the cell potential reaches the set minimum (0.01 V) or maximum (2.0 V) value. The C-rates in galvanostatic cycling were calculated using Faraday's law:

$$C - rate = \frac{{Qm}_{sp}}{I} ,$$

where the theoretical capacity of graphite, Q is 372 mAh/g and mₛₚ denotes a mass of annealed soot particles in the composite electrode. In all galvanostatic tests, coin cell batteries were first cycled 3 times to allow the formation of solid-electrolyte interface (SEI) layers. The capacity retention and rate capability of the soot composite electrode were then investigated by conducting galvanostatic cycle experiments at various rates. The experiments were performed at least twice, and the average values based on repeated experiments are presented.

During cyclic voltammetry, the cell potential was increased and decreased at a constant rate (μV/s) between 0.01 and 2.0 V vs Li^{+/0}. Cyclic voltammetry experiments were performed at different rates (between 25 and 2500 μV/s) to investigate the charging mechanism of Li ions into annealed soot particles. Electrochemical impedance spectroscopy (EIS) was conducted on the pristine and cycled cells using a Biologic potentiostat equipped with EC-EC-Lab® acquisition software.

Structural and Morphological Characterization: X-ray diffraction (XRD) patterns were captured using a Bruker D8 Advance XRD with Lynxeye Detector. A Witec alpha300 Raman microscope was used to identify carbon-related bands using a 532 nm laser and a 50× objective lens with a power of 2.5-3.5 mW and integration time of 2.5 s. X-ray photoelectron spectroscopy (XPS) measurements were taken with a Kratos Axis Ultra DLD spectrometer.

### Results and Discussion

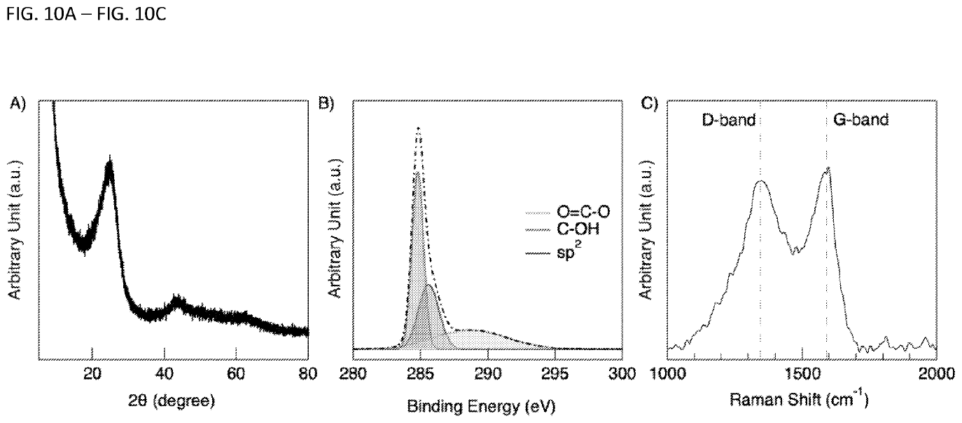

Material Characterization: The structure and chemical composition of the diesel soot particles were characterized by using high resolution transmission electron microscope (HRTEM), powder X-ray diffraction (XRD), Raman spectroscopy, and X-ray photoelectron spectroscopy (XPS) measurements. The crystal structure of the annealed soot particles was investigated using XRD, as shown in FIG. 10A. It is a well-known phenomenon that the high number of structural defects in the layered structure of graphite produces strong distortions of the diffraction peaks. This distortion cannot be avoided as it is an intrinsic feature of graphitized carbon. Despite this distortion, two diffraction peaks were observed near 24.7° and 43.8°, corresponding to the (002) diffraction peak for parallel graphene sheets and the (100) peak from the covalently bonded structure of carbon atoms within each graphene sheet, respectively. Without being bound by theory, these results suggest the presence of graphitized carbon in the structure of annealed soot particles. High-resolution XPS C1s spectra are shown in FIG. 10B. The C1s spectrum is found to be a combination of three peaks at 285, 286, and 289 eV, which correspond to sp² C—C, C—OH, and O═C—O bonds, respectively. The areal percentage of these peaks was calculated, and the percentage of sp² C—C, C—OH, and O═C—O peaks were found to be 43.0, 27.8, and 29.2%, respectively.

The Raman spectra of the pristine soot composite electrode are shown in FIG. 10C. The presence of two peaks, a D-band at ˜1350 cm⁻¹ and a G-band at ˜1580 cm⁻¹, is a distinctive feature of graphitized carbon. The first peak, at ˜1340 cm⁻¹ is caused by the A_{1g} vibration associated with defects in the aromatic rings and can be attributed to amorphization of the carbon structure. The second peak at ˜1580⁻¹ is caused by the E_{2g} vibration of the sp² hybridized carbon atoms. The ratio of the intensity of these two peaks (I_{D}/I_{G}) is commonly used to evaluate the degree of disorder present in graphitized carbon. For the pristine soot composite electrodes, the I_{D}/I_{G} ratio was measured to be 0.94. The average particle size of the soot particles was measured to be around 20-30 nm.

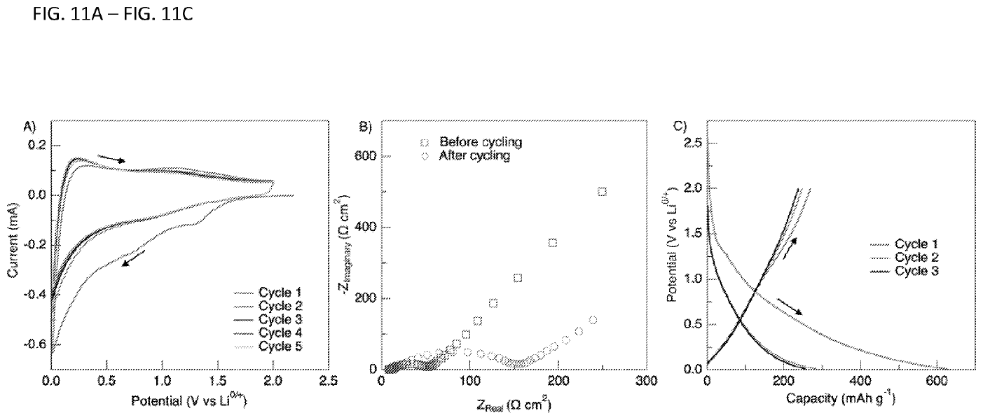

Electrochemical Behavior of Soot Composite Electrode: The electrochemical properties of the soot composite electrodes were evaluated using a variety of electrochemical experiments, as shown in FIG. 11A-FIG. 11C. First, cyclic voltammetry (CV) was performed to investigate reversible and irreversible electrochemical reactions during the initial cycles. During CV, the potential changes linearly with time at a constant rate between the two cutoff voltages. FIG. 11A shows the current evolution during the first five cycles of CV between 0.01-2.0 V vs Li/Li^{0/+} at a scan rate of 200 μV s⁻¹. During the first cathodic scan (i.e. potential sweep from higher potential to lower potential), a broader current peak was detected at 1.26 and 0.76 V. These peaks disappeared in the subsequent cycle, indicating that they are due to the formation of the solid-electrolyte interface (SEI) on the electrode from electrolyte decomposition. Irreversible reduction current peaks were detected for various carbonaceous electrodes during the first cycle due to the electrolyte decomposition. For carbonaceous electrodes, the cathodic peak between 0.01-0.2V is associated with reversible Li-ion intercalation, and the anodic peak at around 0.25 V results from Li-ion extraction from the host structure. Similar electrochemical behavior is observed for the soot composite anode in FIG. 11A. A reversible and sharp cathodic peak was observed around 0.01 V in the first five cycles, associated with the lithiation of the soot composite electrode. During the anodic scan (i.e. increasing from lower potential to higher potential), a broad and reversible current peak was detected around 0.25 V in the first five cycles, indicating delithiation of the electrode. Without being bound by theory, interestingly, the current profile of the electrode beyond the first cathodic cycle demonstrates a quasi-rectangular shape without pronounced redox peaks, indicating that the electrode material may possess a considerable pseudocapacitive contribution to charge storage. The capacitive behavior of the electrode as performed by cyclic voltammetry at different scan rates is discussed below herein.

Electrochemical impedance spectroscopy (EIS) is a common method for quantifying the relationship between current and voltage in an electrochemical cell through an equivalent circuit that represents physical processes occurring in the cell. EIS was applied to the composite electrode before and after cyclic voltammetry measurements, as shown in FIG. 11B. The purpose of the EIS measurement is to investigate changes in cell resistance. The surface resistance is associated with the electron transfer reaction occurring on the electrode's surface and it has a direct relationship with the radius of the real impedance portion of the semicircle. The radius of the semi-circle increased from 50.9 Ω/cm² before cycling to 150.7 Ω/cm² after five cycles. Without being bound by theory, this increase indicates a higher resistance to the electron transfer reaction occurring on the electrode and can be attributed to increased resistance to Li⁺ diffusion through the surface film caused by the formation and growth of the SEI layer.

The charge/discharge capacity of the electrode was analyzed by performing galvanostatic measurements at a C/2 rate for the first 3 cycles, as shown in FIG. 11C. C-rates are calculated based on the theoretical capacity of graphite (372 mAh/g). The composite electrodes display a large first cycle lithiation capacity of 625.3 mAh g⁻¹, which quickly reduced to 285 and 257 mAh g⁻¹ during the 2^{nd} and 3^{rd} lithiation cycles, respectively. During the first discharge cycle, the slope of the potential vs capacity curve changes dramatically at around 1.25 V. Without being bound by theory, this observation further supports the contribution of SEI growth on the large discharge capacity in the first cycle. The large discharge capacity drop between the first and second cycles is attributed to the formation of an SEI layer on the electrode surface. It also agrees well with the increase in the resistance in FIG. 11B. The delithiation capacities during the first three cycles were 268, 247, and 237 mAh g⁻¹, respectively. Beyond the first discharge cycle, the potential-capacity curves show an almost linear relationship. This is in contrast to traditional graphite anodes which display a series of plateaus during galvanostatic cycling, caused associated by the phase transformations between different stages of graphite during (de)lithiation. A quasi-linear relationship between potential and capacity in the soot composite electrode suggests the capacitive behavior of the electrode, which will be discussed later.

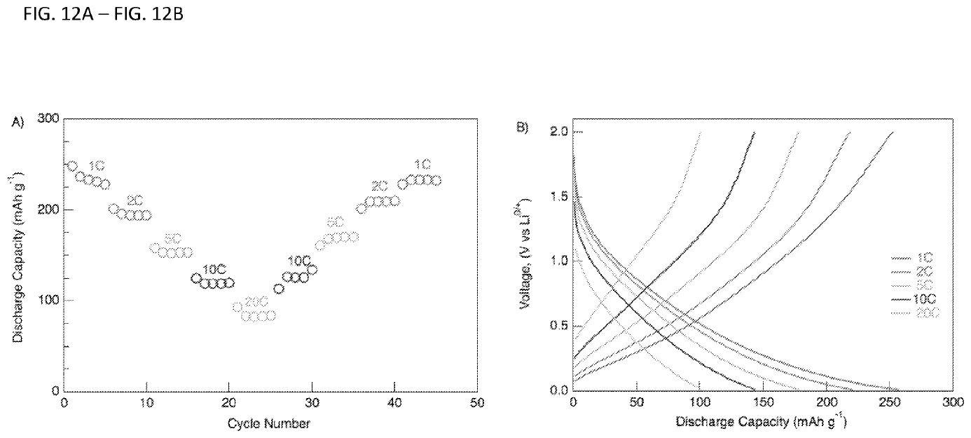

Rate Capability: The rate-capability of the soot composite electrodes was tested by performing galvanostatic cycling at different rates. FIG. 12A shows the charge/discharge capacities and Coulombic efficiencies at 1 C, 2 C, 5 C, 10 C, and 20 C-rates. The electrode was cycled for five consecutive cycles at each scan rate. The electrodes display excellent rate performance with charge capacities of 233, 194, 150, 118, and 82 mAh g⁻¹ during the first cycle at C-rates of 1C, 2C, 5C, 10C, and 20C, respectively. Additionally, when the C-rate was restored to its initial value of 1C, a capacity of 229 mAh/g was retained which demonstrates the high reversibility of the charge storage. Compared to the literature listed in the Table 1, the composite soot electrode demonstrated very competitive performance. The potential-capacity plots for different scan rates are shown in FIG. 12B. The potential curves retain their shape with respect to capacity at various rates, and the potential profiles lack any distinct voltage plateaus, further indicating the capacitive charge storage mechanisms in addition to Li-ion intercalation.

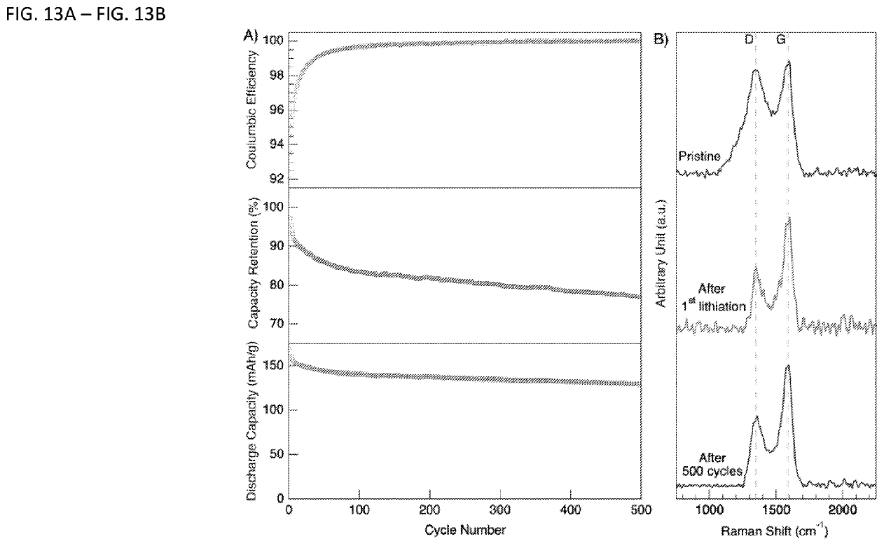

Cycle Life of the Soot Composite Electrode: The cycle life of the soot composite electrodes was tested by performing long-term galvanostatic cycling. FIG. 13A shows the average charge/discharge capacities, capacity retention, and Coulombic efficiency for soot electrodes cycled at a 4C rate for 500 cycles. Before the cycle life testing, the electrode was charged/discharged three times for SEI formation and stabilization. The initial charge and discharge capacities of the electrode were 168 and 154 mAh/g, respectively, but decreased steadily throughout the initial 10-15 cycles. The charge and discharge capacities became reversible at 148 and 152 mAh/g after 15 cycles, respectively. The capacity retention was calculated by taking the ratio of the capacity at the current cycle over the first cycle:

$$Capacity retention = \frac{{Q}_{n}}{{Q}_{1}} \times 100 \% .$$

The discharge capacity retention was about 90% by cycle 10 and decreased to 80% when the electrode was cycled 300 times, indicating highly reversible Li-ion storage ability of the soot composite anode. The Coulombic efficiency was calculated as the ratio between charge extracted (delithiation, Q_{charge)} to charge inserted (lithiation, Q_{charge} for each cycle:

$$CE = \frac{{Q}_{charge}}{{Q}_{discharge}} \times 100 \% .$$

The Coulombic efficiency rose steadily over cycling from its initial value and reaches 99.99% by cycle 500. Complimentary Raman analysis was conducted to better understand the high-capacity retention in the soot composite electrode. FIG. 13B shows the Raman spectra of the pristine electrode, electrode after 1^{st} lithiation and electrode after 500 cycles. The ratio of I_{D}/I_{G} decreased after the first lithiation, demonstrating an increase in ordering of the soot carbon with Li intercalation. The I_{D}/I_{G} ratio does not change significantly between after 1^{st} lithiation and after 500 cycles, indicating that structural ordering is retained in the soot carbon.

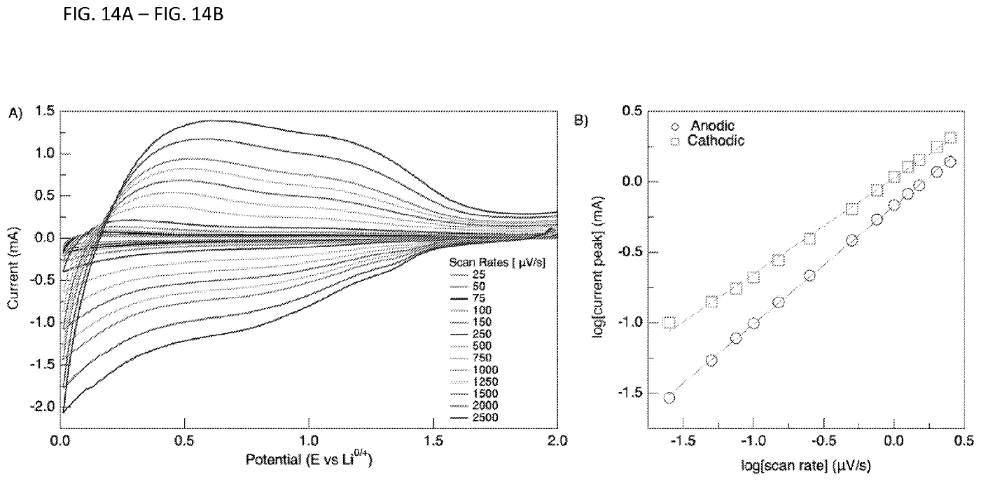

Charging Kinetics of Li⁺ in Soot Composite Anode: Cyclic voltammetry experiments were conducted at various scan rates to investigate the kinetics of lithium-ion storage in the soot composite electrode. Previous research efforts have utilized cyclic voltammetry to interrogate whether the charge storage mechanism in a material is based on intercalation or capacitive behavior. By conducting CV at different scan rates, the difference in reaction kinetics between intercalation (which is diffusion-limited) and capacitive mechanisms can be exploited to ascertain their contributions to charge storage. The current response of the soot composite electrode cycled at a range of scan rates from 25-2500 μV/s is shown in FIG. 14A. We can quantify the diffusion-controlled and surface capacitive-controlled contributions through the application of the following power-law relationship between current and scan rate:

i=av^{b} Eqn. 1

where i is peak current, v is the scan rate, and a and b are fitting parameters. If the b-value is equal to 0.5, it indicates diffusion-controlled process charge storage behavior. On the other hand, if the b-value is equal to 1.0, then it suggests surface-capacitive controlled charge behavior in the electrode. Plots of log(|i|) vs log(|v|) were generated from the CV data, and the slopes of lines fitted to the data were taken as the b-values for the peak currents in the cathodic and anodic sweeps (FIG. 14B).

Based on these power-law fits, the b-values for the anodic and cathodic peaks were 0.84 and 0.68, respectively. These values suggest a combination of diffusion-controlled and surface-capacitive controlled mechanisms for the lithium-ion storage in the soot composite electrode. Further separation of the diffusion-controlled and pseudocapacitive mechanisms of charge storage was accomplished using the method of Dunn et al. (Pseudocapacitive contributions to electrochemical energy storage in TiO 2 (anatase) nanoparticles. J. Phys. Chem. C 111, 14925-14931 (2007)). At each potential in the CV curve, there is a current contribution from both the intercalation and surface-controlled electron transfer reactions. The insertion process is diffusion-limited and will vary with the square root of the scan rate according to the equation

$$i = {nFAC}^{*} {{D}^{\frac{1}{2}} ( \frac{α nF}{RT} )}^{\frac{1}{2}} {π}^{\frac{1}{2}} χ ( bt ) {𝓋}^{1 / 2} \qquad Eqn . 2$$

where n is the number of electrons involved in the electron transfer reaction, F is the Faraday constant, A is the surface area of the electrode, C* is the surface concentration of the electrode material, D is the chemical diffusion coefficient, α is the charge transfer coefficient, R is the ideal gas constant, T is the temperature, and χ(bt) is a function representing the normalized current for an irreversible system. In contrast, the surface-controlled mechanism will be directly proportional to the scan rate according to the following equation:

i=C_{D}Av Eqn. 3

where C_{D} is the capacitance. At a fixed potential, the contribution of the diffusion-limited and capacitive processes on the current can be defined as:

i(V)=k₁v+k₂v^{0.5} Eqn. 4

where k₁ and k₂ represent the capacitive and interaction contributions, respectively. Therefore, if values of k₁ and k₂ are found over the range of potentials in the CV, then the individual contribution of each process can be identified. To assist with this, Eqn. 4 was re-arranged into the form:

$$\frac{i ( V )}{{υ}^{0.5}} = {k}_{1} {𝓋}^{0.5} + {k}_{2} \qquad Eqn . 5$$

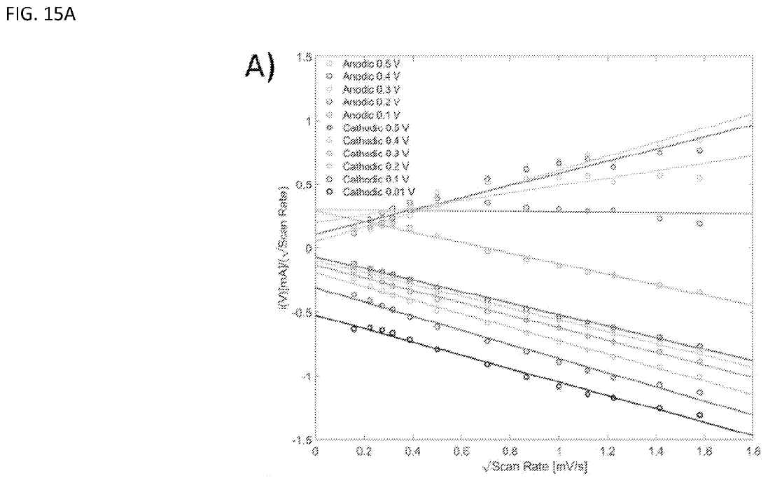

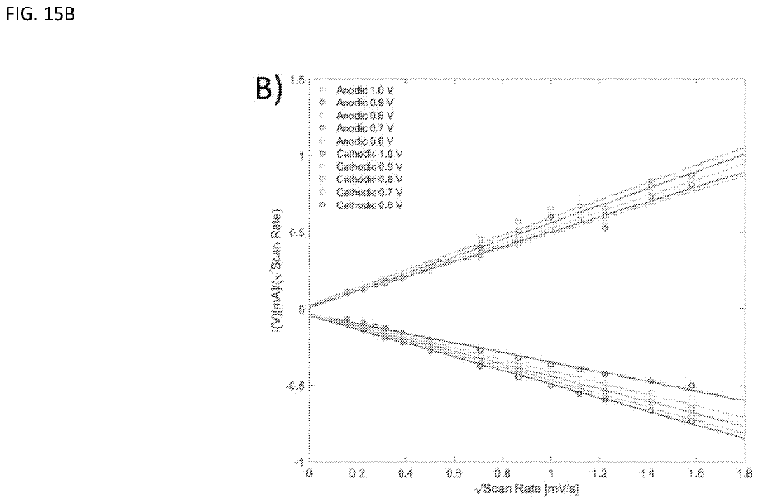

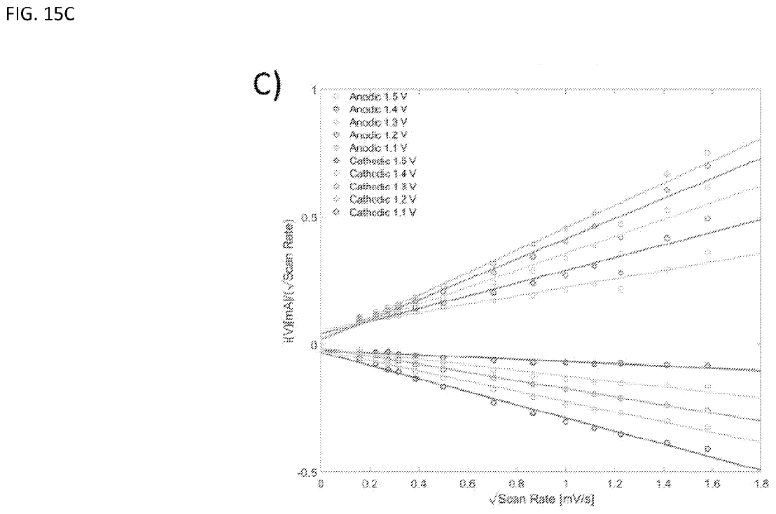

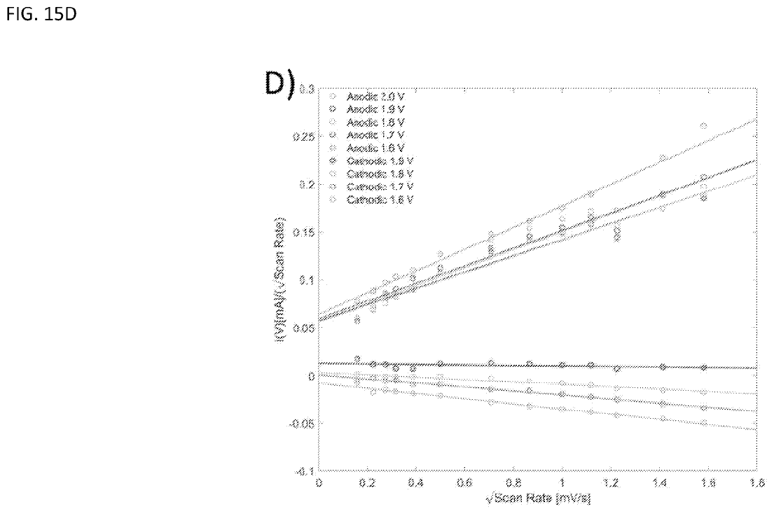

which allows for calculating k₁ and k₂ values from linear fits of i(V)/v^{0.5} vs v^{0.5} plots, where k₁ is the slope and k₂ is the y-intercept in FIG. 15A-FIG. 15D at various potentials. The k₁ and k₂ values produced from the graphs in FIG. 14A are provided in Table 2 alongside the R² value of the line fit to the data points. These values are used to calculate the current produced from the capacitive processes according to the following equation:

i_{cap}(V)=k₁v Eqn. 6

TABLE 2
K-Values Extracted From FIG. 14A
K-Values

| Cathodic | | | | Anodic | | | |
|---|---|---|---|---|---|---|---|
| Potential [V] | k1 | k2 | R\hat{ }2 | Potential [V] | k1 | k2 | R\hat{ }2 |
| 0.01 | −0.5239 | −0.5254 | 0.9894 | 0.01 | | | |
| 0.1 | −0.5541 | −0.3112 | 0.9887 | 0.1 | −0.4115 | 0.2891 | 0.9835 |
| 0.2 | −0.5291 | −0.1951 | 0.9949 | 0.2 | −0.019 | 0.3007 | 0.019 |
| 0.3 | −0.4867 | −0.1363 | 0.9957 | 0.3 | 0.2893 | 0.2008 | 0.7782 |
| 0.4 | −0.4652 | −0.0965 | 0.9963 | 0.4 | 0.4752 | 0.1097 | 0.9246 |
| 0.5 | −0.4524 | −0.0687 | 0.9969 | 0.5 | 0.5537 | 0.0545 | 0.9592 |
| 0.6 | −0.4456 | −0.0465 | 0.997 | 0.6 | 0.5731 | 0.0209 | 0.9807 |
| 0.7 | −0.4333 | −0.0359 | 0.9973 | 0.7 | 0.5568 | 0.0048 | 0.9883 |
| 0.8 | −0.4053 | −0.0367 | 0.9959 | 0.8 | 0.5223 | 0.0055 | 0.9879 |
| 0.9 | −0.3767 | −0.0322 | 0.9959 | 0.9 | 0.4888 | 0.0127 | 0.9867 |
| 1 | −0.3135 | −0.0361 | 0.9922 | 1 | 0.4718 | 0.016 | 0.9893 |
| 1.1 | −0.2572 | −0.0299 | 0.9882 | 1.1 | 0.4382 | 0.0193 | 0.981 |
| 1.2 | −0.2007 | −0.022 | 0.9895 | 1.2 | 0.3961 | 0.0182 | 0.9738 |
| 1.3 | −0.1598 | −0.0126 | 0.9968 | 1.3 | 0.3315 | 0.0264 | 0.9588 |
| 1.4 | −0.1092 | −0.0133 | 0.96 | 1.4 | 0.2492 | 0.0419 | 0.9469 |
| 1.5 | −0.044 | −0.0223 | 0.9171 | 1.5 | 0.1662 | 0.0588 | 0.954 |
| 1.6 | −0.0269 | −0.0082 | 0.9837 | 1.6 | 0.1134 | 0.0639 | 0.9646 |
| 1.7 | −0.0211 | 0.0006 | 0.9878 | 1.7 | 0.0921 | 0.0594 | 0.961 |
| 1.8 | −0.0125 | 0.0032 | 0.9424 | 1.8 | 0.0852 | 0.0561 | 0.9608 |
| 1.9 | −0.0026 | 0.0124 | 0.1978 | 1.9 | 0.0845 | 0.0574 | 0.9567 |
| 2 | | | | 2 | 0.0934 | 0.0567 | 0.9473 |

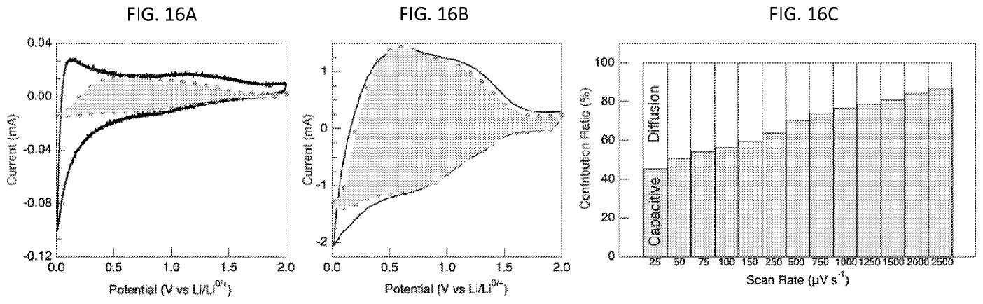

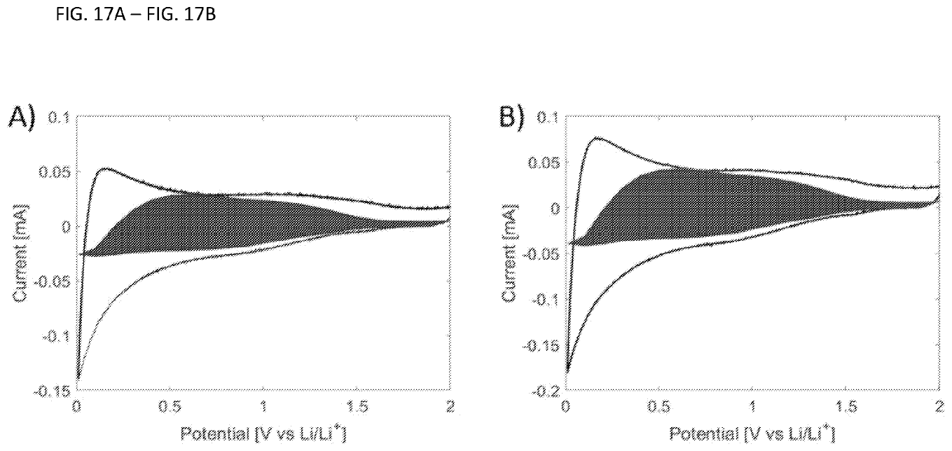

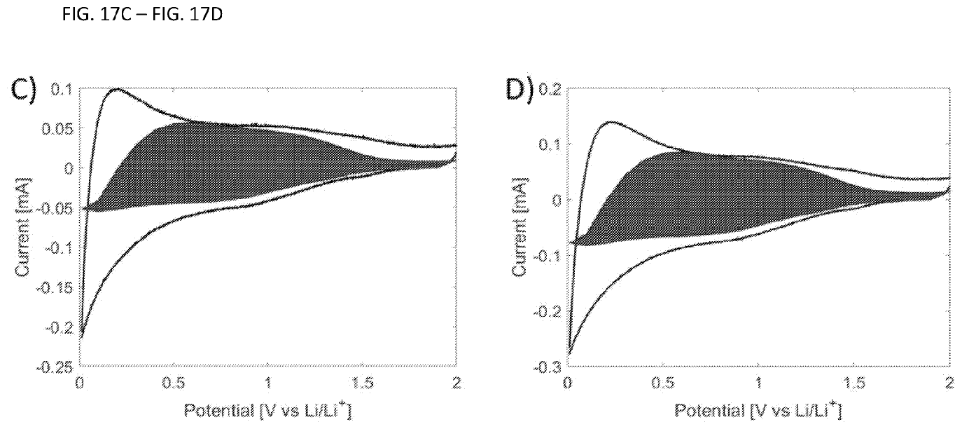

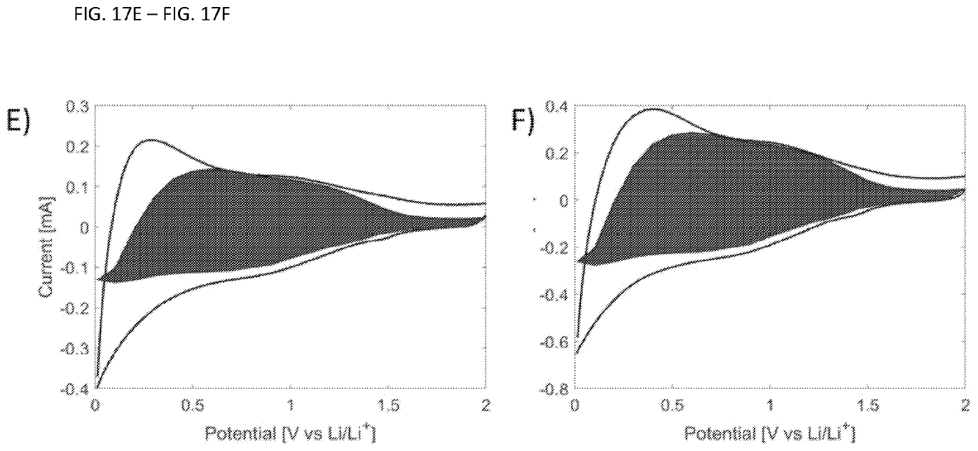

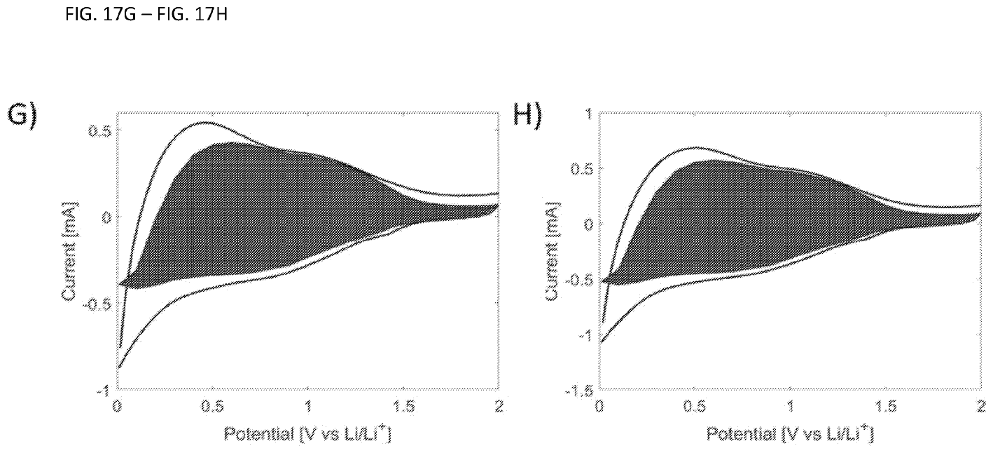

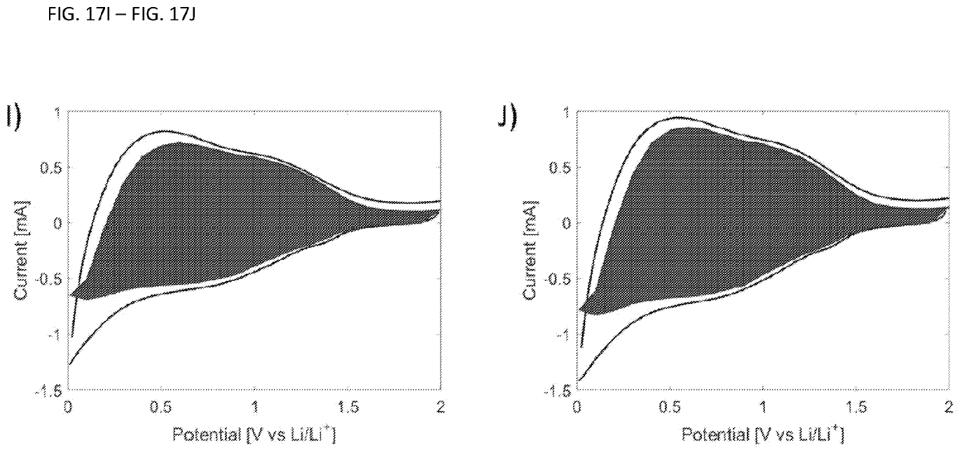

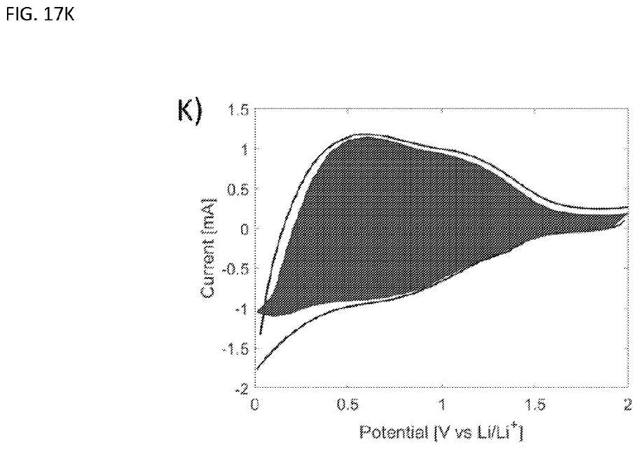

The contribution of capacitive behavior to the current is plotted on top of the experimentally recorded current profiles when the electrode is cycled at 25 and 2500 μV/s in FIG. 16A and FIG. 16B. Contributions of the capacitive charge storage are also presented for the other scan rates in FIG. 17A-FIG. 17K. FIG. 16C illustrates the overall contribution of capacitive and diffusion-controlled processes on the discharge capacity of the electrode at various scan rates. The relative contribution is calculated by numerically approximating the area under the curve of the overall current response and the capacitive current response using the trapezoidal rule at each scan rate and dividing the area of the capacitive current response by the overall current response, as follows:

$$relative contribution = \frac{{A}_{capacitive}}{{A}_{overall}} * 100 \% .$$

At the slowest scan rate of 25 μV/s, the capacitive contribution is about 45.8% of the total charge storage, indicating that insertion is the primary contributor to the charge storage at this rate. However, with increasing the scan rate, the capacitive contribution significantly increases to account for 87.1% of the total charge storage when cycled at 2500 μV/s. The intercalation of Li ions into the electrode structure is a diffusion-controlled process. The pseudocapacitive mechanism involves the adsorption of ions onto the electrode surface alongside an accompanying faradaic charge transfer. As a result, the surface-capacitive charge storage mechanism has much faster kinetics than the diffusion-controlled intercalation of Li ions into the annealed soot particles. For this reason, the capacitive charge storage mechanism provides a large contribution to charge storage at faster scan rates.

In conclusion, we demonstrate the ability of annealed diesel soot particulate matter to store Li⁺ ions as an anode electrode in Li-ion batteries. The structure and chemical composition of the annealed soot particles were characterized by X-ray diffraction, Raman spectroscopy, and X-ray photoelectron spectroscopy. The electrochemical behavior of the soot composite electrode was investigated by performing cyclic voltammetry, impedance spectroscopy, and galvanostatic cycling. The soot composite electrode demonstrated highly reversible discharge capacities when cycled at fast rates up to 20C. The electrode also demonstrated a remarkable capacity retention (77% after 500 cycles) with an initial discharge capacity of 154 mAh/g when cycled at a 4C rate. Raman analysis on the cycled electrode shed light on structural retention of the soot electrode after 500 cycles. Cyclic voltammetry analysis at different scan rates demonstrated the pseudo-capacitive behavior of the soot electrode, which provided remarkable rate ability for fast charging. The remarkable electrochemical performance of soot composite electrodes suggests new directions to ensure the provision of energy and protecting the environment at the same time. Transportation vehicles such as, but not limited to, Naval ships, large trucks, trains, and airplanes are still heavily dependent on fossil fuels with different variety of chemical impurities. The utilization of waste products from the combustion of fuels from these vehicles and others into valuable products for electrochemical storage devices can reduce the release of toxic materials into the earth's atmosphere and can promote the development of new electrode materials for energy storage devices.

Performance of Soot Composite Anode in Na-Ion Batteries

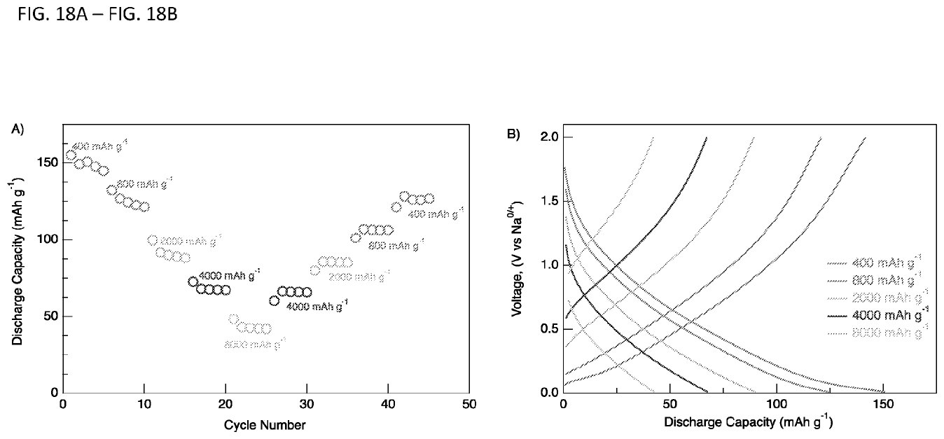

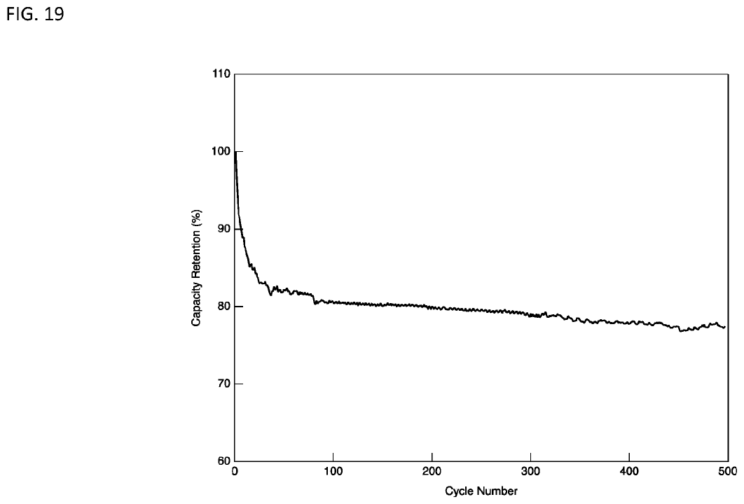

We also investigated the ability of the soot electrode to store Na-ions as an anode electrode. The soot electrode was cycled against sodium counter electrode in 1M NaClO₄ in EC:DMC electrolyte. The charge/discharge capacity of the soot composite electrode in Na-ion battery at various rates was analyzed by applying constant current density of 400, 800, 2000, 4000 and 8000 mA/g (FIG. 18A). The electrode was cycled for five consecutive cycles at each constant current density. The discharge capacity of the electrode was 155, 132, 99, 72 and 48 mAh/g when discharged at constant current density of 400, 800, 2000, 4000 and 8000 mA/g, respectively. The discharge capacity reduced to 126 mAh/g when applied current density was 400 mA/g at the cycle number 45. Compared to the literature listed in the Table 1, the composite soot electrode demonstrated much better discharge capacity at similar scan rates for Na-ion batteries. The potential-capacity plots for different scan rates for Na-ion storage are shown in FIG. 18B. The potential curves retain their shape with respect to capacity at various rates. Similar to Li-ion storage in FIG. 12B, the potential profiles in FIG. 18A lack any distinct voltage plateaus, further indicating the capacitive charge storage mechanism for Na-ions too.

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

It is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention.

1. An electrode for a battery, the electrode comprising an active material, wherein the active material is diesel exhaust soot particles.

2. The electrode of claim 1, wherein the electrode further comprises a binder, and an electrically conductive additive.

3. The electrode of claim 2, wherein the binder is a polymeric binder.

4. The electrode of claim 2, wherein the binder is selected from the group consisting of a carboxymethyl cellulose, carboxymethyl cellulose sodium salt, and combinations thereof.

5. The electrode of claim 2, wherein the electrically conductive additive is a conductive carbon material.

6. The electrode of claim 5, wherein the conductive carbon material is conductive carbon black.

7. The electrode of claim 1, wherein the diesel exhaust soot particles are annealed.

8. The electrode of claim 1, wherein the diesel exhaust soot particles comprise amorphous carbon.

9. The electrode of claim 8, wherein the amorphous carbon is porous amorphous carbon.

10. The electrode of claim 1, wherein the electrode is a composite electrode.

11. The electrode of claim 1, wherein the diesel exhaust soot particles are recycled diesel exhaust soot particles.

12. The electrode of claim 1, wherein the diesel exhaust soot particles are about 20 nm to about 200 nm in diameter.

13. The electrode of claim 1, wherein the electrode has a cycle life of at least about 500 cycles.

14. The electrode of claim 1, wherein the electrode is capable of pseudocapacitive charging.

15. The electrode of claim 1, wherein the electrode is an anode electrode.

16. The electrode of claim 1, wherein the electrode is capable of storing and discharging ions, wherein the ions are selected from the group consisting of lithium ions, sodium ions, potassium ions, and combinations thereof.

17. The electrode of claim 1, wherein the battery is capable of being charged in a time period, wherein the time period is selected from 3 minutes to 60 minutes.

18. The electrode of claim 1, wherein the battery is selected from the group consisting of a lithium ion battery, a sodium ion battery, a potassium ion battery, and combinations thereof.

19. The electrode of claim 1, wherein the battery is selected from the group consisting of a rechargeable lithium ion battery, a rechargeable sodium ion battery, a rechargeable potassium ion battery, and combinations thereof.

20. The electrode of claim 1, wherein the battery is capable of storing and discharging ions, wherein the ions are selected from the group consisting of lithium ions, sodium ions, potassium ions, and combinations thereof.

21. The electrode of claim 1, wherein the battery is capable of pseudocapacitive charging.

22.-41. (canceled)

42. A method of manufacturing an electrode of claim 1 for a battery, comprising:
collecting diesel exhaust soot particles;
annealing the diesel exhaust soot particles;
mixing the annealed diesel exhaust soot particles with a binder, water, and an electrically conductive additive to form a slurry;
casting the slurry on a current collector; and
drying the slurry to provide the electrode.

43.-59. (canceled)

60. A battery, comprising: the anode electrode of claim 15, a cathode electrode, a separator, and an electrolyte.
